(19) United States
(12) Patent Application Publication
(10) Pub. No.: US 2026/0343152 A1
(43) Pub. Date: Oct. 29, 2026

(54) TRANSDUCER DEVICES

(71) Applicants: SHENZHEN SHOKZ CO., LTD., Shenzhen (CN); SOUND SOLUTIONS (ZHENJIANG) INTERNATIONAL CO., LTD., Zhenjiang (CN)

(72) Inventors: Guangyuan ZHU, Shenzhen (CN); Lei ZHANG, Shenzhen (CN); Xin QI, Shenzhen (CN); Manuel MEFLEH, Vienna (AT); Christian KRONBICHLER, Vienna (AT)

(73) Assignees: SHENZHEN SHOKZ CO., LTD., Shenzhen (CN); SOUND SOLUTIONS (ZHENJIANG) INTERNATIONAL CO., LTD., Zhenjiang (CN)

(21) Appl. No.: 19/709,237

(22) Filed: Jun. 16, 2026

Related U.S. Application Data
(63) Continuation of application No. PCT/CN2025/119109, filed on Sep. 4, 2025.

(30) Foreign Application Priority Data
Dec. 13, 2024 (CN) 202411844311.6

(51) Int. Cl. H04R 9/02; H04R 9/06; H04R 9/18

(52) U.S. Cl. CPC H04R 9/025; H04R 9/063; H04R 9/18

(57) ABSTRACT

A transducer device is provided, including: a first magnetic circuit assembly including a first magnet; a voice coil assembly; a resilient plate assembly; an auxiliary magnetic circuit assembly including a second magnet and a third magnet. The second and third magnets are spaced apart in a first direction parallel to an axis of the voice coil assembly. The second and third magnets are spaced apart from the first magnet in a second direction. The second direction is perpendicular to the axis of the voice coil assembly. The dynamic component further includes a magnetic conductive plate. The magnetic conductive plate is disposed on a surface of the first magnet along the first direction. A polarity of a surface of the first magnet facing the magnetic conductive plate along the first direction is opposite to a polarity of a surface of the second magnet facing the dynamic component along the second direction.

### CROSS-REFERENCE TO RELATED APPLICATIONS

This application is a continuation of International Patent Application No. PCT/CN 2025/119109, filed on Sep. 4, 2025, which claims priority to Chinese Application No. 202411844311.6, filed on Dec. 13, 2024, the entire contents of which are incorporated herein by reference.

### TECHNICAL FIELD

The present disclosure relates to the field of acoustic technology, and in particular, to a transducer device.

### BACKGROUND

With the development of acoustic output technology, loudspeakers have been widely used in people's daily lives, and can be used in conjunction with electronic devices such as mobile phones and computers to provide users with an auditory feast. In a loudspeaker, in order to ensure that the loudspeaker has good output performance across the full frequency band, it is generally necessary to design the vibration structure of the loudspeaker so that the loudspeaker has a strong driving force while having a resonance frequency in the mid-low frequency range, thereby enabling the loudspeaker to have high sensitivity while also having good output performance in the mid-low frequency range.

### SUMMARY

An embodiment of the present disclosure provides a transducer device, comprising: a first magnetic circuit assembly, including a dynamic component and a static component, wherein the static component is disposed around the dynamic component, and the dynamic component includes a first magnet; a voice coil assembly, wherein the voice coil assembly is fixed to the static component, at least a portion of the voice coil assembly is located in a magnetic gap between the static component and the dynamic component, the dynamic component is movable relative to the voice coil assembly and the static component, and the voice coil assembly includes at least one voice coil; a resilient plate assembly, configured to connect the dynamic component and the static component and to allow the dynamic component to move relative to the static component in a first direction, wherein the first direction is parallel to an axis of the voice coil assembly; an auxiliary magnetic circuit assembly, including a second magnet and a third magnet, wherein the second magnet and the third magnet are spaced apart in the first direction, and both the second magnet and the third magnet are spaced apart from the first magnet in a second direction, and the second direction is perpendicular to the axis of the voice coil assembly; wherein the dynamic component further includes a magnetic conductive plate, the magnetic conductive plate is disposed on a surface of the first magnet along the first direction, a polarity of a surface of the first magnet facing the magnetic conductive plate along the first direction is opposite to a polarity of a surface of the second magnet facing the dynamic component along the second direction, and the polarity of the surface of the first magnet facing the magnetic conductive plate along the first direction is opposite to a polarity of a surface of the third magnet facing the dynamic component along the second direction; and in the first direction, the second magnet and the third magnet are located on two sides of the magnetic conductive plate, respectively.

### BRIEF DESCRIPTION OF THE DRAWINGS

The present disclosure is further described in an exemplary manner by embodiments, and these exemplary embodiments are described in detail with reference to the drawings. These embodiments are not limiting. In these embodiments, the same reference numerals denote the same structures, wherein:

FIG. 1 is a schematic diagram illustrating an exemplary structure of a speaker according to some embodiments of the present disclosure;

FIGS. 2A and 2B are schematic diagrams illustrating an exemplary structure of a transducer device according to some embodiments of the present disclosure;

FIGS. 3A and 3B are schematic diagrams illustrating movement positions of a dynamic component according to some embodiments of the present disclosure;

FIGS. 4A and 4B are schematic diagrams illustrating different structures of a transducer device according to some embodiments of the present disclosure;

FIG. 5 to FIG. 7 are schematic diagrams illustrating magnetic force curves during movement of a dynamic component when a second magnet is embedded in a static component according to some embodiments of the present disclosure;

FIG. 8 is a schematic diagram illustrating an exemplary structure of a static component according to some embodiments of the present disclosure;

FIG. 9 is a schematic diagram illustrating another exemplary structure of the transducer device according to some embodiments of the present disclosure;

FIGS. 10A and 10B are schematic diagrams illustrating movement positions of a dynamic component according to some embodiments of the present disclosure;

FIGS. 11A and 11B are schematic diagrams illustrating yet another exemplary structure of the transducer device according to some embodiments of the present disclosure;

FIGS. 12A and 12B are schematic diagrams illustrating yet another exemplary structure of the transducer device according to some embodiments of the present disclosure;

FIGS. 13A and 13B are schematic diagrams illustrating yet another exemplary structure of the transducer device according to some embodiments of the present disclosure;

FIG. 14A is a schematic diagram illustrating yet another exemplary structure of the transducer device according to some embodiments of the present disclosure; and

FIG. 14B is a schematic diagram illustrating yet another exemplary structure of the transducer device according to some embodiments of the present disclosure.

### DETAILED DESCRIPTION

To more clearly illustrate the technical solutions of the embodiments of the present disclosure, a brief introduction will be made to the accompanying drawings to be used in the description of the embodiments. It is evident that the drawings in the following description are merely some examples or embodiments of the present disclosure, and for those skilled in the art, the present disclosure may also be applied to other similar scenarios according to these drawings without making creative efforts. It should be understood that these exemplary embodiments are provided merely to enable those skilled in the relevant art to better understand and implement the present disclosure, and are not intended to limit the scope of the present disclosure in any way. Unless explicitly indicated or apparent from the context, the same reference numerals in the drawings represent the same structures or operations.

As shown in the present disclosure and the claims, unless the context clearly indicates otherwise, the terms “a”, “an”, “one”, and/or “the”, or the like, are not limited to the singular, but may also include the plural. Generally speaking, the terms “comprising” and “including” merely indicate that explicitly identified steps and elements are included, and these steps and elements do not constitute an exclusive enumeration, and a manner or a device may also include other steps or elements. The term “based on” refers to “at least partially based on”. The term “an embodiment” refers to “at least one embodiment”; the term “another embodiment” refers to “at least one additional embodiment”.

In the description of the present disclosure, it should be understood that the indicated orientation or positional relationship is based on the orientation or positional relationship shown in the drawings, merely for the convenience of describing the present disclosure and simplifying the description, and is not intended to indicate or imply that the device or element being referred to must have a specific orientation, or be constructed and operated in a specific orientation, thus, it should not be understood as a limitation on the present disclosure.

Furthermore, the terms “first” and “second” are merely used for descriptive purposes, and should not be understood as indicating or implying the count of technical features indicated. Thus, a feature defined with “first” or “second” may explicitly or implicitly include at least one such feature. In the description of the present disclosure, the meaning of “a plurality of” refers to at least two, for example, two, three, or the like, unless otherwise expressly and specifically defined.

In the present disclosure, unless otherwise expressly stipulated and defined, the terms “mount”, “be connected”, “connect”, “fix”, or the like, should be understood in a broad sense, for example, it may be a fixed connection, a detachable connection, or an integrated one; it may be a mechanical connection or an electrical connection; it may be directly connected or indirectly connected through an intermediate medium; it may be an internal communication between two elements or an interaction relationship between two elements, unless otherwise expressly defined. For those skilled in the art, the specific meanings of the above terms in the present disclosure may be understood according to specific circumstances.

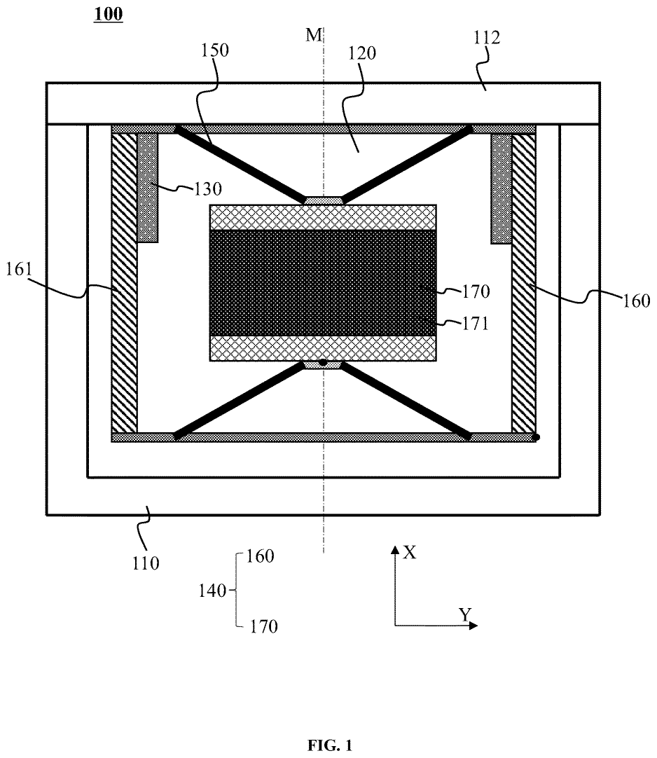

FIG. 1 is a schematic diagram illustrating an exemplary structure of a speaker according to some embodiments of the present disclosure. As shown in FIG. 1, some embodiments of the present disclosure provide a speaker 100, which includes a housing 110 and a transducer device 120. The transducer device 120 is configured to vibrate to generate sound and transmit the sound to a user through the housing 110.

In some embodiments, the speaker 100 may also be an air-conduction speaker. Correspondingly, the transducer device 120 may be an air-conduction transducer device, and the housing 110 may be provided with a sound outlet (not shown in the figures) acoustically coupled to the transducer device 120. One end of the transducer device 120 in a vibration direction may be connected to a diaphragm, the transducer device 120 drives the diaphragm to vibrate to generate air-conduction sound, and the air-conduction sound is transmitted to an ear canal opening of the user through the sound outlet, so that the user receives the air-conduction sound.

In some embodiments, as shown in FIG. 1, the speaker 100 may be a bone-conduction speaker. Correspondingly, the transducer device 120 may be a bone-conduction transducer device, the housing 110 may include a vibration panel 112 configured to fit a face of the user, the transducer device 120 is connected to the vibration panel 112, and the transducer device 120 is configured to drive the vibration panel 112 to vibrate so that the vibration panel 112 generates bone-conduction sound. In a wearing state, the vibration panel 112 transmits the bone-conduction sound through the face to a cochlea of the user, so that the user receives the bone-conduction sound.

In some embodiments, the speaker 100 may be a bone-air conduction combined speaker, and the count of the transducer device 120 may be one or more. When the count of the transducer device 120 is one, the housing 110 may include the vibration panel 112 and is provided with the sound outlet, and the transducer device 120 may drive the diaphragm to vibrate to generate air-conduction sound while driving the vibration panel 112 to vibrate to generate bone-conduction sound. When the count of the transducer devices 120 is greater than one, at least one transducer device 120 may be an air-conduction transducer device to drive the diaphragm to vibrate to generate the air-conduction sound, and at least another transducer device 120 is a bone-conduction transducer device to drive the vibration panel 112 to vibrate to generate the bone-conduction sound.

In some embodiments, the transducer device 120 includes a voice coil assembly 130, a first magnetic circuit assembly 140, and a resilient plate assembly 150.

The first magnetic circuit assembly 140 includes a static component 160 and a dynamic component 170. The dynamic component 170 includes a first magnet 171, the static component 160 includes a magnetic conductor 161 arranged to at least partially surround the dynamic component 170 (e.g., the first magnet 171), and the magnetic conductor 161 is configured to conduct a magnetic field generated by the dynamic component 170 (e.g., the first magnet 171).

The voice coil assembly 130 is fixed to the static component 160, and at least a portion of the voice coil assembly 130 is located in a magnetic gap between the static component 160 and the dynamic component 170 (e.g., a magnetic gap formed between the magnetic conductor 161 and the dynamic component 170). The dynamic component 170 is movable relative to the voice coil assembly 130 and the static component 160. The voice coil assembly 130 includes at least one voice coil, and a direction of an axis M of the voice coil assembly 130 is consistent with the vibration direction of the transducer device 120. In some embodiments, the voice coil assembly 130 may include two voice coils, and the two voice coils are respectively located at least partially in magnetic gaps at two ends of the transducer device 120 along the vibration direction.

The resilient plate assembly 150 is configured to connect the dynamic component 170 and the static component 160 and to allow the dynamic component 170 to move relative to the static component 160 in a first direction X, and the first direction X is parallel to the axis M of the voice coil assembly 130. In some embodiments, the static component 160 is connected to the housing 110, and the dynamic component 170 vibrates relative to the static component 160 and the housing 110. During a movement of the dynamic component 170 relative to the static component 160, the resilient plate assembly 150 provides a first restoring force to restore the dynamic component 170 to a balanced position, the first magnetic circuit assembly 140 (e.g., the static component 160) provides a second restoring force to restore the dynamic component 170 to the balanced position, and the first restoring force and the second restoring force enable the dynamic component 170 to have a tendency to return to the balanced position. The first restoring force provided by the resilient plate assembly 150 may interact with the second restoring force provided by the first magnetic circuit assembly 140 to jointly adjust the vibration difficulty of the dynamic component 170, thereby adjusting the driving force of the transducer device 120 and adjusting the output performance of the speaker 100. The balanced position refers to a relative position of the dynamic component 170 and the static component 160 when the voice coil assembly 130 is not energized.

In some embodiments, one end of the transducer device 120 along the vibration direction may be connected to the housing 110 to achieve fixation of the transducer device 120. In some embodiments, two ends of the transducer device 120 along the vibration direction may be respectively connected to the housing 110 to achieve fixation of the transducer device 120. In some embodiments, an outer side surface of the transducer device 120 (e.g., an outer side surface of the static component 160 or an outer side surface of the magnetic conductor 161) may be connected to the housing 110 to achieve the fixation of the transducer device 120.

In some embodiments, to lower an F0 characteristic resonance frequency of the transducer device 120 and to improve the output performance of the loudspeaker 100, the transducer device 120 may be designed to improve the driving force thereof. For example, an auxiliary magnetic circuit assembly may be designed to provide a compensating force that causes the dynamic component 170 to deviate away from the balanced position. This may counteract a partial restoring force provided by the first magnetic circuit assembly 140 and the resilient plate assembly 150 that restores the dynamic component 170 to the balanced position, thereby lowering the movement difficulty of the dynamic component 170 and further improving the driving force of the transducer device 120.

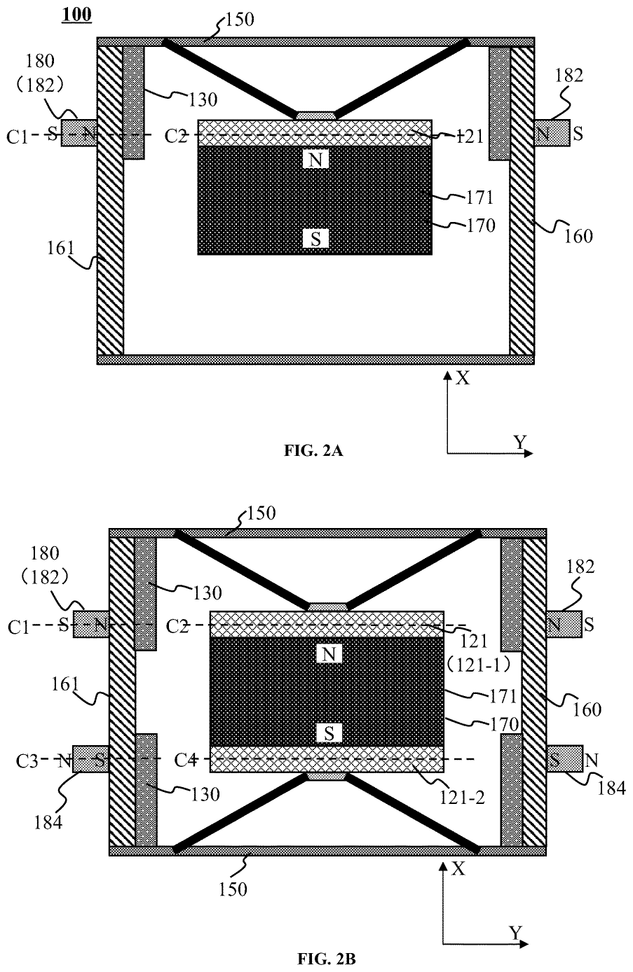

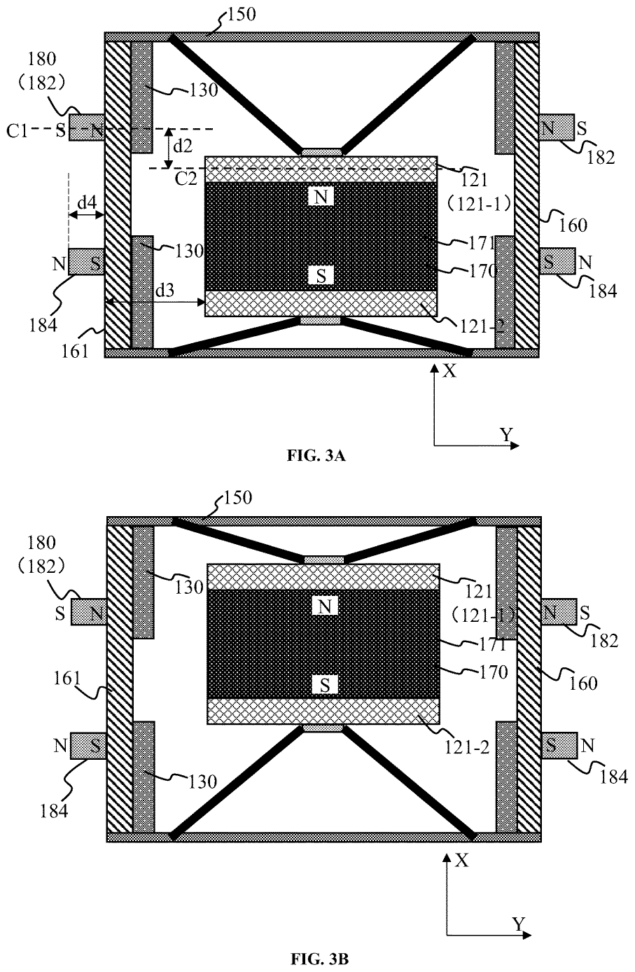

FIGS. 2A and 2B are schematic diagrams illustrating an exemplary structure of a transducer device according to some embodiments of the present disclosure. Please refer to FIG. 2A. The transducer device 120 further includes an auxiliary magnetic circuit assembly 180. The auxiliary magnetic circuit assembly 180 includes a second magnet 182. The second magnet 182 and the first magnet 171 are spaced apart in a second direction Y. During a movement of the dynamic component 170 relative to the static component 160, the first magnetic circuit assembly 140 provides a second restoring force to restore the dynamic component 170 to the balanced position. The resilient plate assembly 150 provides a first restoring force to restore the dynamic component 170 to the balanced position. The auxiliary magnetic circuit assembly 180 interacts with the first magnet 171 to provide a force that causes the dynamic component 170 to deviate away from the balanced position. That is, the auxiliary magnetic circuit assembly 180 interacts with the first magnetic circuit assembly 140 to provide the compensating force that causes the dynamic component 170 to deviate away from the balanced position. In this case, the first restoring force provided by the resilient plate assembly 150 may interact with the compensating force cooperatively provided by the auxiliary magnetic circuit assembly 180 and the first magnetic circuit assembly 140. This interaction may jointly adjust the vibration difficulty of the dynamic component 170, thereby adjusting the driving force of the transducer device 120, adjusting an F0 characteristic of the transducer device 120, and adjusting the output performance of the loudspeaker 100. For more details regarding an operating process of the auxiliary magnetic circuit assembly 180, please refer to subsequent FIG. 3A, FIG. 3B, and related descriptions, which will not be repeated herein.

In some embodiments, in order that the force provided by the auxiliary magnetic circuit assembly 180 can counteract at least a partial second restoring force provided by the first magnetic circuit assembly 140, and to enable the auxiliary magnetic circuit assembly 180 and the first magnetic circuit assembly 140 to cooperatively provide the compensating force, an angle between a polarization direction of the first magnetic circuit assembly 140 and a polarization direction of the auxiliary magnetic circuit assembly 180 is 80° to 100°. In some embodiments, the polarization direction of the first magnetic circuit assembly 140 may be perpendicular to the polarization direction of the auxiliary magnetic circuit assembly 180. The polarization direction of the auxiliary magnetic circuit assembly 180 may refer to a polarization direction of any magnet (e.g., the second magnet, a third magnet, a fourth magnet, or the like) of the auxiliary magnetic circuit assembly 180.

In some embodiments, when the resilient plate assembly 150 includes only one vibration transmission plate, the vibration transmission plate may be disposed at any one end of the dynamic component 170 along the first direction X. In this case, the voice coil assembly 130 may include only one voice coil. The voice coil is at least partially extended into a magnetic gap between the end of the dynamic component 170 provided with the vibration transmission plate and the static component 160, as shown in FIG. 2A.

In some embodiments, when the resilient plate assembly 150 includes two vibration transmission plates, the two vibration transmission plates are respectively connected to two ends of the dynamic component 170 along the first direction X. In this case, the voice coil assembly 130 may include two voice coils. The two voice coils are respectively at least partially located in magnetic gaps corresponding to the two ends of the dynamic component 170 along the first direction X, as shown in FIG. 2B. The arrangement of the two vibration transmission plates may improve the vibration stability of the transducer device 120 and improve the output quality of the loudspeaker 100.

In some embodiments, the two vibration transmission plates of the resilient plate assembly 150 allow the dynamic component 170 to vibrate relative to the static component 160, and the vibration produces at least one resonance peak within a frequency range of 100 Hz to 200 Hz. That is, the output of the loudspeaker 100 includes resonance peaks with frequencies within a range of 100 Hz to 200 Hz, thereby improving the output of the loudspeaker 100 in mid-low frequencies (e.g., a frequency band below 250 Hz), and enabling the loudspeaker 100 to have better output performance in mid-low frequencies.

In some embodiments, the dynamic component 170 includes a magnetic conductive plate 121. The magnetic conductive plate 121 is disposed on a surface of the first magnet 171 along the first direction X. The magnetic conductive plate 121 connects the first magnet 171 and the resilient plate assembly 150. A polarity of the surface of the first magnet 171 facing the magnetic conductive plate 121 along the first direction X is the same as a polarity of a surface of the second magnet 182 facing the dynamic component 170 along the second direction Y. The second magnet 182 and the first magnet 171 repel each other. Illustratively, as shown in FIG. 2A, the magnetic conductive plate 121 is disposed on an upper side surface of the first magnet 171 along the first direction X. The upper side surface of the first magnet 171 is an N pole, and the surface of the second magnet 182 facing the dynamic component 170 along the second direction Y is an N pole.

In some embodiments, the second magnet 182 is disposed on an outer periphery side of the static component 160 (e.g., the magnetic conductor 161), to avoid the second magnet 182 from entering the magnetic gap as much as possible, and to avoid interfering with the magnetic field of the first magnetic circuit assembly 140.

In some embodiments, a first distance in the first direction X between the magnetic conductive plate 121 and the second magnet 182 is less than or equal to 0.8 mm. This is to ensure the repulsion between the second magnet 182 and the first magnet 171, to prevent the second magnet 182 and the first magnet 171 from being too far apart, and to ensure that the auxiliary magnetic circuit assembly 180 provides the sufficient force that causes the dynamic component 170 to deviate away from the balanced position. This enables the auxiliary magnetic circuit assembly 180 and the first magnetic circuit assembly 140 to cooperatively provide the compensating force that causes the dynamic component 170 to deviate away from the balanced position. In some embodiments, to ensure that the auxiliary magnetic circuit assembly 180 provides a sufficient force, the first distance in the first direction X between the magnetic conductive plate 121 and the second magnet 182 is less than or equal to 0.55 mm.

The first distance in the first direction X between the magnetic conductive plate 121 and the second magnet 182 may refer to a distance in the first direction X between a centerline plane C2 of the magnetic conductive plate 121 parallel to the second direction Y and a centerline plane C1 of the second magnet 182 parallel to the second direction Y, for example, a first distance d2 as shown in FIG. 3A. The centerline plane C2 of the magnetic conductive plate 121 parallel to the second direction Y refers to that the magnetic conductive plate 121 has a cross-sectional shape in a cross-section along the first direction X (e.g., a plane passing through the axis M). The cross-sectional shape has a centerline perpendicular to the first direction X. A plane formed by different centerlines corresponding to different cross-sections is the centerline plane. For example, in FIG. 3A, the cross-sectional shape of the magnetic conductive plate 121 is a rectangle shape. The rectangle shape has a centerline perpendicular to the first direction X, and a plane where the centerline is located and which is perpendicular to the first direction X is the centerline plane C2 of the magnetic conductive plate 121. In some embodiments, the dynamic component 170 may move upward or downward relative to the static component 160 in the first direction X based on the balanced position. The first distance in the first direction X between the magnetic conductive plate 121 and the second magnet 182 being less than or equal to 0.8 mm refers to that the second magnet 182 may be disposed within a region where the magnetic conductive plate 121 moves upward or downward by 0.8 mm, with the magnetic conductive plate 121 at the balanced position as a reference.

In some embodiments, a thickness of the second magnet 182 in the first direction X and the first distance d2 may affect a magnitude of the force provided by the auxiliary magnetic circuit assembly 180 to the dynamic component. This may thereby affect a magnitude of the compensating force cooperatively provided by the auxiliary magnetic circuit assembly 180 and the first magnetic circuit assembly 140. In some embodiments, to make the magnitude of the compensating force cooperatively provided by the auxiliary magnetic circuit assembly 180 and the first magnetic circuit assembly 140 appropriate, a ratio of the first distance d2 to the thickness of the second magnet 182 in the first direction X may be 0 to 1.3. In some embodiments, to prevent the force provided by the auxiliary magnetic circuit assembly 180 from being too small, which may result in the auxiliary magnetic circuit assembly 180 and the first magnetic circuit assembly 140 being unable to cooperatively provide the compensating force in a direction opposite to the direction of the first restoring force, the ratio of the first distance d2 to the thickness of the second magnet 182 in the first direction X may be 0.5 to 1.0. In some embodiments, to further make the magnitude of the compensating force cooperatively provided by the auxiliary magnetic circuit assembly 180 and the first magnetic circuit assembly 140 appropriate, the ratio of the first distance d2 to the thickness of the second magnet 182 in the first direction X may be 0.7 to 0.8.

In some embodiments, when the resilient plate assembly 150 includes only one vibration transmission plate, the vibration transmission plate and the magnetic conductive plate 121 may be disposed at the same end or different ends of the first magnet 171 along the first direction X. Illustratively, the magnetic conductive plate 121 may be disposed on the upper side surface of the first magnet 171 along the first direction X, and the vibration transmission plate may be disposed on a lower side surface of the first magnet 171 along the first direction X. Alternatively, the magnetic conductive plate 121 may be disposed on the upper side surface of the first magnet 171 along the first direction X, and the vibration transmission plate may be disposed on the magnetic conductive plate 121, as shown in FIG. 2A. Alternatively, the magnetic conductive plate 121 may be disposed on the lower side surface of the first magnet 171 along the first direction X, and the vibration transmission plate may be disposed on the upper side surface of the first magnet 171 along the first direction X. Alternatively, the magnetic conductive plate 121 may be disposed on the lower side surface of the first magnet 171 along the first direction X, and the vibration transmission plate may be disposed on the magnetic conductive plate 121.

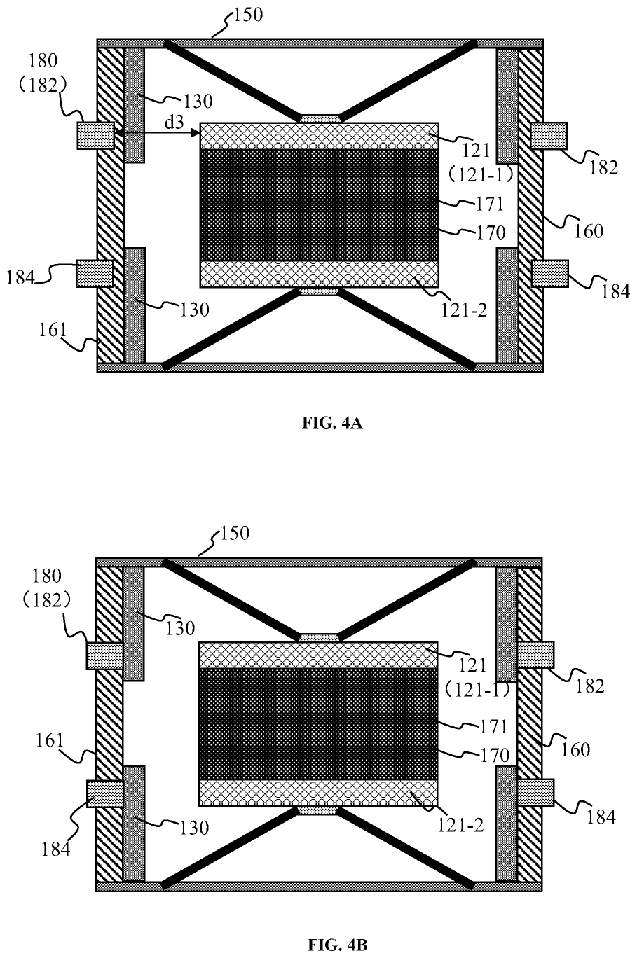

In some embodiments, in the second direction Y, a second distance between a side surface of the second magnet 182 facing the first magnet 171 and a side surface of the magnetic conductive plate 121 facing the second magnet 182 (such as a second distance d3 as shown in FIG. 3A and FIG. 4A) may reflect a magnitude of the force of the second magnet 182 on the first magnet 171. If the second distance is too large, that is, the first magnet 171 and the second magnet 182 are too far apart, the force of the second magnet 182 on the first magnet 171 is small, and the force provided by the auxiliary magnetic circuit assembly 180 is small. This may lead to a small counteraction, or almost no counteraction, of a total force provided by the auxiliary magnetic circuit assembly 180 on the first magnetic circuit assembly 140. That is, the force provided by the auxiliary magnetic circuit assembly 180 is less than the second restoring force provided by the first magnetic circuit assembly 140. The force cooperatively provided by the auxiliary magnetic circuit assembly 180 and the first magnetic circuit assembly 140 is still the compensating force that restores the dynamic component 170 to the balanced position. This results in a small improvement of the driving force of the transducer device 120 by the auxiliary magnetic circuit assembly 180, and a small improvement of the output performance of the loudspeaker 100. If the second distance is too small, this may cause the magnetic gap between the static component 160 and the dynamic component 170 to be too small, affecting installation and vibration of the voice coil assembly 130. In some embodiments, to ensure that the second magnet 182 provides a sufficient force, and to reduce an influence on the magnetic gap and the voice coil, the second distance is 0.4 mm to 1.9 mm. In some embodiments, to ensure normal operation of the loudspeaker 100, the second distance is 0.5 mm to 1.5 mm. In some embodiments, to ensure normal operation of the loudspeaker 100 while ensuring that the second magnet 182 provides a sufficient force, the second distance may be 0.6 mm to 1.2 mm.

In some embodiments, the second magnet 182 has a width d4 in the second direction Y, as shown in FIG. 3A. The larger the width d4 of the second magnet 182, the stronger the magnetism of the second magnet 182 is, and the greater the force of the second magnet 182 on the first magnet 171 is. In some embodiments, to ensure that the second magnet 182 provides a sufficient force, the width d4 of the second magnet 182 in the second direction Y may be 0.6 mm to 1.2 mm. In some embodiments, to enable the second magnet 182 to have an appropriate magnetism, the width d4 of the second magnet 182 in the second direction Y may be 0.8 mm to 1.0 mm.

In some embodiments, to ensure that the second magnet 182 provides a sufficient force, a ratio of the second distance d3 to the width d4 of the second magnet 182 in the second direction Y is 0.3 to 3.2. In some embodiments, to enable the second magnet 182 to have an appropriate magnetism, the ratio of the second distance d3 to the width d4 of the second magnet 182 in the second direction Y is 0.5 to 2.5.

FIGS. 3A and 3B are schematic diagrams illustrating movement positions of a dynamic component according to some embodiments of the present disclosure.

Please refer to FIG. 2A, FIG. 2B, and FIG. 3A. In FIG. 2A and FIG. 2B, the dynamic component 170 is in the balanced position. When the dynamic component 170 moves downwards relative to the static component 160 in the first direction X as shown in FIG. 3A, the second magnet 182 is closer to the upper side surface of the first magnet 171, and the second magnet 182 is further away from the lower side surface of the first magnet 171. The force exerted by the second magnet 182 on the first magnet 171 is mainly the repulsive force of the second magnet 182 on the upper side surface of the first magnet 171, and the attractive force of the second magnet 182 on the lower side surface of the first magnet 171 can be ignored. When the dynamic component 170 moves downwards relative to the static component 160 in the first direction X as shown in FIG. 3A, the repulsive force of the second magnet 182 on the upper side surface of the first magnet 171 is downwards. That is, the second magnet 182 provides a force to cause the dynamic component 170 to deviate away from the balanced position, and the auxiliary magnetic circuit assembly 180 interacts with the first magnetic circuit assembly 140 to provide the compensating force to cause the dynamic component 170 to deviate away from the balanced position.

Please refer to FIG. 2A, FIG. 2B, and FIG. 3B. In FIG. 2A and FIG. 2B, the dynamic component 170 is in the balanced position. When the dynamic component 170 moves upwards relative to the static component 160 in the first direction X as shown in FIG. 3B, the second magnet 182 is closer to the upper side surface of the first magnet 171, and the second magnet 182 is further away from the lower side surface of the first magnet 171. The force exerted by the second magnet 182 on the first magnet 171 is mainly the repulsive force of the second magnet 182 on the upper side surface of the first magnet 171, and the attractive force of the second magnet 182 on the lower side surface of the first magnet 171 can be ignored. When the dynamic component 170 moves upwards relative to the static component 160 in the first direction X as shown in FIG. 3A, the repulsive force of the second magnet 182 on the upper side surface of the first magnet 171 is upwards. That is, the second magnet 182 provides a force to cause the dynamic component 170 to deviate away from the balanced position, and the auxiliary magnetic circuit assembly 180 interacts with the first magnetic circuit assembly 140 to provide the compensating force to cause the dynamic component 170 to deviate away from the balanced position.

It should be noted that, for content related to the force exerted by the resilient plate assembly 150 on the dynamic component 170 during the movement of the dynamic component 170, please refer to FIG. 3A, FIG. 3B, and related descriptions thereof in the foregoing, which will not be redundantly described herein.

In some embodiments, the force exerted by the second magnet 182 on the first magnet 171 includes a force along the first direction X and a component force along the second direction Y. In some embodiments, the second magnet 182 has a symmetric structure in the second direction Y, so that the component forces of the second magnet 182 on the first magnet 171 along the second direction Y can cancel each other out, thereby minimizing generation of an offset of the dynamic component 170 in the second direction Y, improving the vibration stability of the transducer device 120, and improving the output quality of the speaker 100.

When the dynamic component 170 moves relative to the static component 160 in the first direction X, the first restoring force provided by the resilient plate assembly 150 prevents the continued movement of the dynamic component 170, and the compensating force cooperatively provided by the auxiliary magnetic circuit assembly 180 (the second magnet 182) and the first magnetic circuit assembly 140 (the static component 160) promotes the continued movement of the dynamic component 170. That is, the force exerted by the second magnet 182 on the dynamic component 170 may offset the second restoring force provided by the first magnetic circuit assembly 140, and cause the force cooperatively provided by the auxiliary magnetic circuit assembly 180 and the first magnetic circuit assembly 140 to be the compensating force that causes the dynamic component 170 to deviate away from the balanced position, thereby reducing the difficulty of the continued movement of the dynamic component 170, and thus indirectly increasing the F0 characteristic of the transducer device 120, improving the driving force of the transducer device 120, and improving the output performance of the speaker 100.

To avoid the movement range of the dynamic component 170 being excessively large, which may cause the dynamic component 170 to interfere with other components (e.g., vibration transmission plates, the housing 110, or the like), thereby affecting normal use, in some embodiments, in the first direction X, the movement distance of the dynamic component 170 relative to the balanced position is 0 mm to 1.0 mm. It should be noted that, in the first direction X, the movement distance of the dynamic component 170 relative to the balanced position being 0 mm to 1.0 mm refers to that the movement distance of the dynamic component 170 upwards along the first direction X relative to the balanced position does not exceed 1.0 mm, and the movement distance downwards along the first direction X does not exceed 1.0 mm. In some embodiments, to further avoid the dynamic component 170 interfering with other components, in the first direction X, the movement distance of the dynamic component 170 relative to the balanced position is 0 mm to 0.8 mm.

FIGS. 4A and 4B are schematic diagrams illustrating different structures of a transducer device according to some embodiments of the present disclosure.

Please refer to FIG. 2A and FIG. 2B. In some embodiments, the second magnet 182 is attached to the outer periphery side of the static component 160 (e.g., the magnetic conductor 161), so that the second magnet 182 and the first magnet 171 have an appropriate distance in the second direction Y.

Please refer to FIG. 4A and FIG. 4B. In some embodiments, a groove structure (not shown in the figures) is provided on the outer periphery side of the static component 160, and at least a portion of the second magnet 182 is embedded in the groove structure, so that while fixing the second magnet 182, the distance between the second magnet 182 and the first magnet 171 in the second direction Y is reduced, the force exerted by the second magnet 182 on the first magnet 171 is increased, the compensating force cooperatively provided by the auxiliary magnetic circuit assembly 180 and the first magnetic circuit assembly 140 is further increased, thereby reducing the F0 characteristic of the transducer device 120, improving the driving force of the transducer device 120, and improving the output performance of the speaker 100.

In some embodiments, when the second magnet 182 is attached to the outer periphery side of the static component 160 or disposed in the groove structure of the static component 160, the voice coil assembly 130 may be directly connected to the static component 160. For example, the voice coil assembly 130 may be attached to the inner side surface of the static component 160; or, a step portion is provided on the inner side surface of the static component 160, and the voice coil assembly 130 is disposed on the step portion. In some embodiments, the voice coil assembly 130 may also be connected to the housing 110, and the static component 160 is connected to the housing 110. In some embodiments, in the second direction Y, there is a gap between the static component 160 and the voice coil assembly 130, thereby facilitating the arrangement of other structures between the static component 160 and the voice coil assembly 130. For example, the second magnet 182 may extend through the static component 160 into the gap between the static component 160 and the voice coil assembly 130.

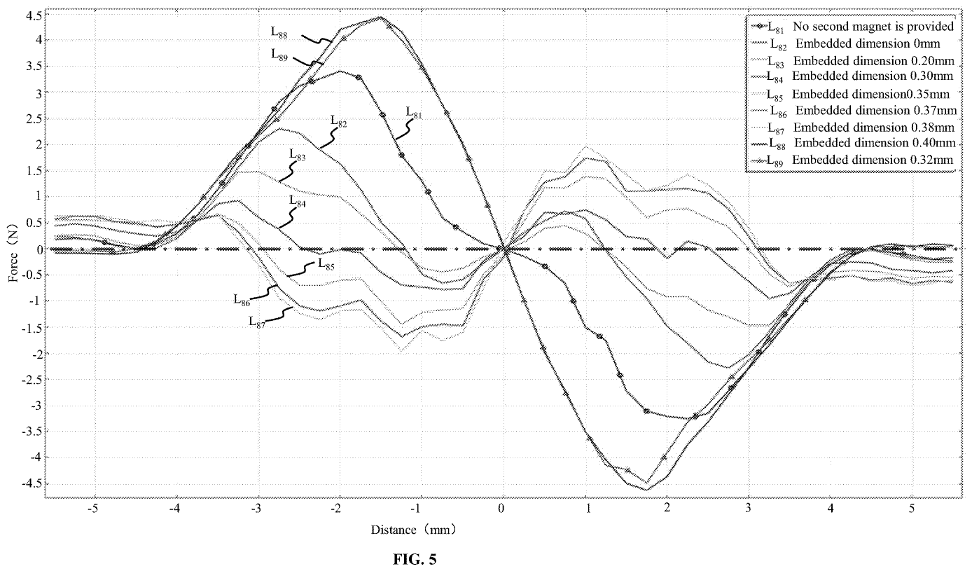

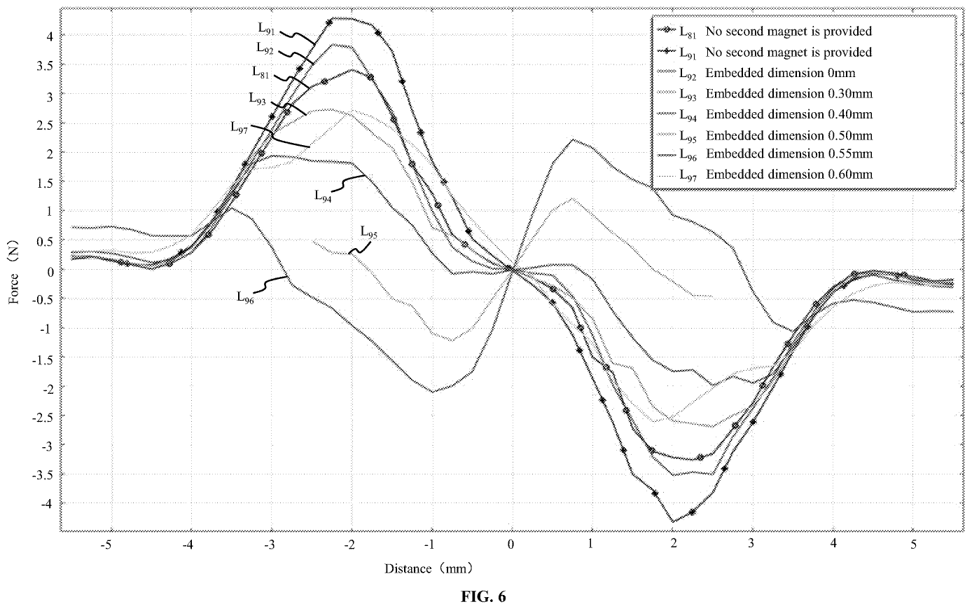

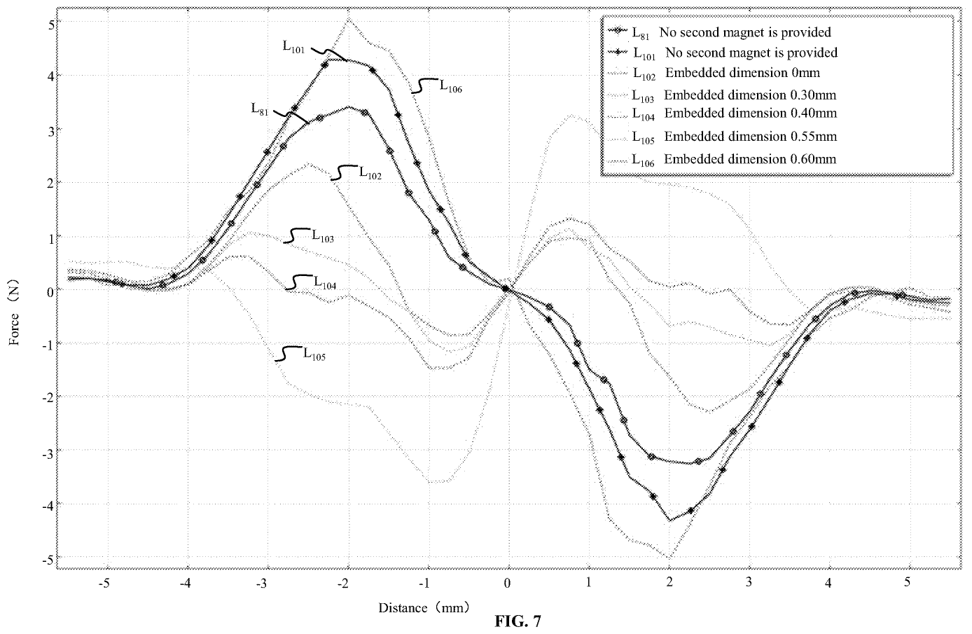

FIG. 5 to FIG. 7 are schematic diagrams illustrating magnetic force curves during movement of a dynamic component when a second magnet is embedded in a static component according to some embodiments of the present disclosure. It should be noted that, the curves shown in FIG. 5 to FIG. 7 are only for the force provided to with the dynamic component 170 by the cooperation of the first magnetic circuit assembly 140 and the auxiliary magnetic circuit assembly 180, and do not consider the first restoring force provided by the resilient plate assembly 150 on the dynamic component 170. For FIG. 5, the thickness of the static component 160 in the second direction Y is 0.4 mm, and the thickness of the second magnet 182 in the first direction X is 0.6 mm. For FIG. 6, the thickness of the static component 160 in the second direction Y is 0.6 mm, and the thickness of the second magnet 182 in the first direction X is 0.6 mm. For FIG. 7, the thickness of the static component 160 in the second direction Y is 0.6 mm, and the thickness of the second magnet 182 in the first direction X is 1.2 mm. The horizontal axis of FIG. 5 to FIG. 7 indicates the position of the dynamic component 170, where 0 indicates that the dynamic component 170 is in the balanced position, negative numbers indicate the distance of the dynamic component 170 moving downwards along the first direction X, and positive numbers indicate the distance of the dynamic component 170 moving upwards along the first direction X. The vertical axis of FIG. 5 to FIG. 7 indicates the force on the dynamic component 170, where negative numbers indicate that the dynamic component 170 is subjected to a force downwards along the first direction X, and positive numbers indicate that the dynamic component 170 is subjected to a force upwards along the first direction X.

Please refer to FIG. 5. A curve L₈₁ indicates the force curve during the movement of the dynamic component 170 when the second magnet 182 is not provided; a curve L₈₂ indicates the force curve during the movement of the dynamic component 170 when the dimension of the second magnet 182 embedded in the static component 160 is 0 mm (that is, the second magnet 182 is attached to the outer side surface of the static component 160); a curve L₈₃ indicates the force curve during the movement of the dynamic component 170 when the dimension of the second magnet 182 embedded in the static component 160 is 0.20 mm; a curve L₈₄ indicates the force curve during the movement of the dynamic component 170 when the dimension of the second magnet 182 embedded in the static component 160 is 0.30 mm; a curve L₈₅ indicates the force curve during the movement of the dynamic component 170 when the dimension of the second magnet 182 embedded in the static component 160 is 0.35 mm; a curve L₈₆ indicates the force curve during the movement of the dynamic component 170 when the dimension of the second magnet 182 embedded in the static component 160 is 0.37 mm; a curve L₈₇ indicates the force curve during the movement of the dynamic component 170 when the dimension of the second magnet 182 embedded in the static component 160 is 0.38 mm; a curve L₈₈ indicates the force curve during the movement of the dynamic component 170 when the dimension of the second magnet 182 embedded in the static component 160 is 0.40 mm (that is, the second magnet 182 just penetrates the static component 160 but does not extend from the inner wall of the static component 160); and a curve L₈₉ indicates the force curve during the movement of the dynamic component 170 when the dimension of the second magnet 182 embedded in the static component 160 is 0.42 mm (that is, the second magnet 182 penetrates the static component 160 and extends from the inner wall of the component 160).

Please refer to curve L₈₁ and curves L₈₂, L₈₃, L₈₄, L₈₅, L₈₆, and L₈₇. Compared with curve L₈₁ where the second magnet 182 is not provided, curves L₈₂ to L₈₇ where the second magnet 182 is provided are overall obviously shifted downwards, which indicates that providing the second magnet 182 can effectively offset the second restoring force provided by the first magnetic circuit assembly 140 on the dynamic component 170, thereby enhancing the vibration performance of the dynamic component 170, improving the driving force of the transducer device 120, reducing the F0 characteristic of the transducer device 120, and improving the output performance of the speaker 100.

Please refer to the left half of curves L₈₂, L₈₃, L₈₄, L₈₅, L₈₆, and L₈₇. It can be seen that, as the dimension of the second magnet 182 embedded in the static component 160 gradually increases, the corresponding curves are distributed from high to low in sequence and gradually shift downwards, and the magnitude of the downward shift gradually decreases. This indicates that as the dimension of the second magnet 182 embedded in the static component 160 gradually increases, the force exerted by the second magnet 182 on the dynamic component 170 (the first magnet 171) gradually increases, and the offsetting effect on the second restoring force provided by the first magnetic circuit assembly 140 on the dynamic component 170 gradually increases, thereby enhancing the vibration performance of the dynamic component 170, improving the driving force of the transducer device 120, reducing the F0 characteristic of the transducer device 120, and improving the output performance of the speaker 100. Meanwhile, as the dimension of the second magnet 182 embedded in the static component 160 gradually approaches the thickness of the static component 160 in the second direction Y, the magnitude of the force increase exerted by the second magnet 182 on the dynamic component 170 (the first magnet 171) gradually decreases.

Please refer to curves L₈₂, L₈₃, L₈₄, L₈₅, L₈₆, and L₈₇. It can be seen that, on curves L₈₂, L₈₃, L₈₄, L₈₅, L₈₆, and L₈₇, the positivity and negativity of the horizontal axis and the vertical axis of points on some sections are present and are the same. For example, the sections where the horizontal axis corresponding to curves L₈₂ and L₈₃ is [−1, 1], the sections where the horizontal axis corresponding to curve L₈₄ is [−2, 2], the sections where the horizontal axis corresponding to curves L₈₅, L₈₆, and L₈₇ is [−3, 3], or the like. This indicates that when the dynamic component 170 moves within the corresponding distance range of the corresponding sections, the direction of the force on the dynamic component 170 is the same as the movement direction, and the direction of the force on the dynamic component 170 deviates away from the balanced position. That is, at this time, the first magnetic circuit assembly 140 and the auxiliary magnetic circuit assembly 180 interact to provide the compensating force that causes the dynamic component 170 to deviate away from the balanced position, which has a significant enhancement effect on the vibration capability of the dynamic component 170.

Please refer to curves L₈₁ and curves L₈₈ and L₈₉. Compared with curve L₈₁ where the second magnet 182 is not provided, curves L₈₈ and L₈₉ where the second magnet 182 penetrates the static component 160 are obviously shifted upwards. This indicates that when the second magnet 182 penetrates the static component 160 and enters the magnetic gap, the force exerted by the second magnet 182 on the dynamic component 170 (the first magnet 171) no longer offsets the second restoring force provided by the first magnetic circuit assembly 140 on the dynamic component 170. Please refer to curve L₈₁ and curves L₈₈ and L₈₉. The positivity and negativity of the horizontal axis and the vertical axis of points on curve L₈₁ and curves L₈₈ and L₈₉ are opposite within a larger interval range, which indicates that when the dynamic component 170 moves downwards or upwards along the first direction X, the direction of the force on the dynamic component 170 is opposite to the movement direction, and the direction of the force on the dynamic component 170 points to the balanced position. That is, at this time, the first magnetic circuit assembly 140 and the auxiliary magnetic circuit assembly 180 interact to provide the restoring force that restores the dynamic component 170 to the balanced position, which has a significant weakening effect on the vibration capability of the dynamic component 170.

In summary, in some embodiments, to reduce the F0 characteristic of the transducer device 120 and to make the speaker 100 have better output performance, the dimension of the second magnet 182 embedded in the static component 160 is less than or equal to the thickness of the static component 160 in the second direction Y, and the ratio of the dimension of the second magnet 182 embedded in the static component 160 to the thickness of the static component 160 in the second direction Y may be 0 to 0.95. In some embodiments, to further ensure the output performance of the speaker 100, the ratio of the dimension of the second magnet 182 embedded in the static component 160 to the thickness of the static component 160 in the second direction Y may be 0 to 0.95.

Referring to FIG. 6, the curve L₈₁ corresponds to the curve L₈₁ in FIG. 5; a curve L₉₁ represents the force curve of the dynamic component 170 during movement when the second magnet 182 is not provided; a curve L₉₂ represents the force curve of the dynamic component 170 during movement when the dimension of the second magnet 182 embedded in the static component 160 is 0 mm (i.e., the second magnet 182 is attached to the outer side surface of the static component 160); a curve L₉₃ represents the force curve of the dynamic component 170 during movement when the dimension of the second magnet 182 embedded in the static component 160 is 0.30 mm; a curve L₉₄ represents the force curve of the dynamic component 170 during movement when the dimension of the second magnet 182 embedded in the static component 160 is 0.40 mm; a curve L₉₅ represents the force curve of the dynamic component 170 during movement when the dimension of the second magnet 182 embedded in the static component 160 is 0.50 mm; a curve L₉₆ represents the force curve of the dynamic component 170 during movement when the dimension of the second magnet 182 embedded in the static component 160 is 0.55 mm; and a the curve L₉₇ represents the force curve of the dynamic component 170 during movement when the dimension of the second magnet 182 embedded in the static component 160 is 0.60 mm (i.e., the second magnet 182 just penetrates the static component 160 but does not extend from the inner wall of the static component 160).

Referring to the left half portions of the curve L₈₁ and the curve L₉₁, the curve L₉₁ is clearly shifted upward compared to the curve L₈₁. This indicates that when the dimension of the second magnet 182 remains unchanged, as the thickness of the static component 160 in the second direction Y increases, the force exerted by the first magnetic circuit assembly 140 (the static component 160) on the dynamic component 170 increases, that is, the second restoring force exerted by the first magnetic circuit assembly 140 and the resilient plate assembly 150 on the dynamic component 170 increases, the vibration performance of the dynamic component 170 decreases, the driving force of the transducer device 120 decreases, the F0 characteristic of the transducer device 120 increases, and the output performance of the speaker 100 decreases.

Referring to the left half portions of the curve L₉₁ and the curves L₉₂, L₉₃, L₉₄, L₉₅, and, compared to the curve L₉₁ where the second magnet 182 is not provided, the curves L₉₂-L₉₆ where the second magnet 182 is provided are clearly shifted downward as a whole, indicating that providing the second magnet 182 can effectively offset the restoring force provided by the resilient plate assembly 150 and the first magnetic circuit assembly 140 to the dynamic component 170, thereby enhancing the vibration performance of the dynamic component 170, increasing the driving force of the transducer device 120, reducing the F0 characteristic of the transducer device 120, and improving the output performance of the speaker 100.

Referring to FIG. 7, the curve L₈₁ corresponds to the curve L₈₁ in FIG. 5; the curve L₁₀₁ represents the force curve of the dynamic component 170 during movement when the second magnet 182 is not provided; the curve L₁₀₂ represents the force curve of the dynamic component 170 during movement when the dimension of the second magnet 182 embedded in the static component 160 is 0 mm (i.e., the second magnet 182 is attached to the outer side surface of the static component 160); the curve L₁₀₃ represents the force curve of the dynamic component 170 during movement when the dimension of the second magnet 182 embedded in the static component 160 is 0.30 mm; the curve L₁₀₄ represents the force curve of the dynamic component 170 during movement when the dimension of the second magnet 182 embedded in the static component 160 is 0.40 mm; the curve L₁₀₅ represents the force curve of the dynamic component 170 during movement when the dimension of the second magnet 182 embedded in the static component 160 is 0.55 mm; and the curve L₁₀₆ represents the force curve of the dynamic component 170 during movement when the dimension of the second magnet 182 embedded in the static component 160 is 0.60 mm (i.e., the second magnet 182 just penetrates the static component 160 but does not extend from the inner wall of the static component 160). The curve L₉₁ and the curve L₁₀₁ both represent the force curve of the dynamic component 170 during movement when the thickness of the static component 160 in the second direction Y is 0.6 mm and the second magnet 182 is not provided. That is, the curve L₉₁ and the curve L₁₀₁ are the same curve.

Referring to the curve L₁₀₁ and the curves L₁₀₂, L₁₀₃, L₁₀₄, and L₁₀₅, compared to when the second magnet 182 is not provided, after the second magnet 182 is provided, on corresponding curves L₁₀₂, L₁₀₃, L₁₀₄, and L₁₀₅, the positivity and negativity of the horizontal axis and the vertical axis of points on some sections are present and are the same, that is, when the dynamic component 170 moves within a corresponding distance range of the corresponding segment, the direction of the force received by the dynamic component 170 is the same as the direction of the movement, the direction of the resultant force received by the dynamic component 170 deviates away from the balanced position, that is, at this time, the first magnetic circuit assembly 140 and the auxiliary magnetic circuit assembly 180 cooperate to provide the compensating force to cause the dynamic component 170 to deviate away from the balanced position, which greatly enhances the vibration capability of the dynamic component 170. This indicates that when the thickness of the second magnet 182 in the first direction X increases, the force exerted by the second magnet 182 on the dynamic component 170 increases, and an offsetting effect on the restoring force provided by the resilient plate assembly 150 and the first magnetic circuit assembly 140 to the dynamic component 170 gradually increases, thereby enhancing the vibration performance of the dynamic component 170, increasing the driving force of the transducer device 120, and improving the output performance of the speaker 100.

In summary, when the thickness of the static component 160 in the second direction Y decreases, the dimension of the second magnet 182 increases, and the dimension of the second magnet 182 embedded in the static component 160 increases (without penetrating the static component 160), the vibration capability of the dynamic component 170 is enhanced, the driving force of the transducer device 120 is increased, the F0 characteristic of the transducer device 120 is reduced, and the output performance of the speaker 100 is improved. In some embodiments, in order to ensure the output performance of the speaker 100, a ratio of the dimension of the second magnet 182 embedded in the static component 160 to the thickness of the static component 160 in the second direction Y may be 0.01 to 0.95, and a ratio of the thickness of the second magnet 182 in the second direction Y to the thickness of the static component 160 in the second direction Y may be 0.6 to 2. In other embodiments, in order to improve the output performance of the speaker 100, the ratio of the dimension of the second magnet 182 embedded in the static component 160 to the thickness of the static component 160 in the second direction Y may also be 0.5 to 1. It should be noted that the thickness of the static component 160 in the second direction Y refers to the thickness of a sidewall of the static component 160 in the second direction Y, and not the dimension of the static component 160 as a whole in the second direction Y. In some embodiments, the thickness of the static component 160 in the second direction Y may refer to the thickness of a region where the groove structure is provided on the sidewall of the static component 160.

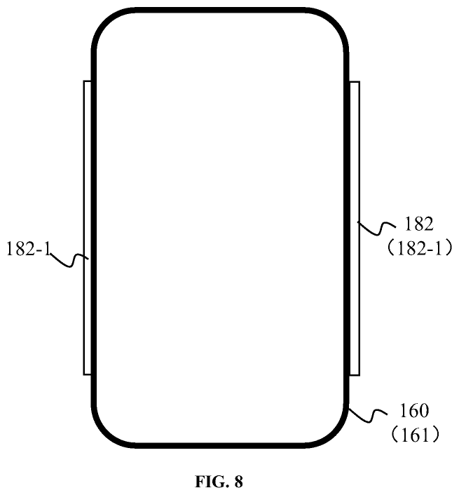

FIG. 8 is a schematic diagram illustrating an exemplary structure of a static component according to some embodiments of the present disclosure. As shown in FIG. 8, in some embodiments, a cross-sectional shape of the static component 160 perpendicular to the first direction X may be a racetrack shape or a rectangle shape, and the cross-sectional shape of the static component 160 may include two long side portions and two short side portions. In some embodiments, the second magnet 182 may include at least two sub-magnets 182-1, the at least two sub-magnets 182-1 may be respectively disposed on the outer periphery side of the static component 160 away from the dynamic component 170, and the at least two sub-magnets 182-1 may be respectively disposed on two opposite side surfaces of the static component 160. For example, the at least two sub-magnets 182-1 may be respectively disposed on outer side surfaces corresponding to two long sides of the cross-sectional shape of the static component 160. A force provided by each of the two sub-magnets 182-1 to the dynamic component 170 in the second direction Y may cancel each other out, thereby minimizing the movement of the dynamic component 170 in the second direction Y. Through the above settings, while reducing an overall weight of the transducer device 120, the second magnet 182 may have the strong magnetism, and the output performance of the speaker 100 may be improved. In other embodiments, the second magnet 182 may also include four sub-magnets 182-1 (not shown in the figures), the four sub-magnets 182-1 may be respectively disposed on outer side surfaces corresponding to the two long side portions and the two short side portions of the static component 160, thereby further enhancing the magnetism of the second magnet 182 and improving the output performance of the speaker 100.

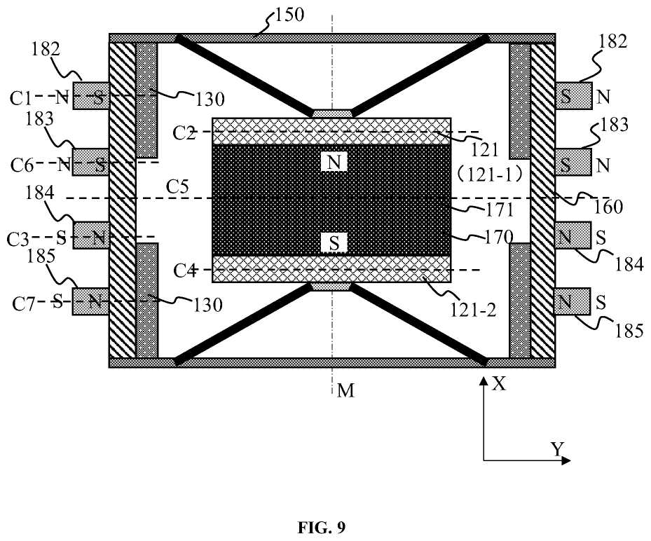

FIG. 9 is a schematic diagram illustrating another exemplary structure of the transducer device according to some embodiments of the present disclosure. Referring to FIG. 9, in some embodiments, the dynamic component 170 may include the magnetic conductive plate 121, and the magnetic conductive plate 121 is disposed on the surface of the first magnet 171 along the first direction X. The auxiliary magnetic circuit assembly 180 further includes a third magnet 183. The second magnet 182 and the third magnet 183 are spaced apart in the first direction X. In the first direction X, the second magnet 182 and the third magnet 183 are respectively located on two sides of the magnetic conductive plate 121. The polarity of the surface of the first magnet 171 facing the magnetic conductive plate 121 along the first direction X is opposite to the polarity of the surface of the second magnet 182 facing the dynamic component 170 along the second direction Y. The second magnet 182 and the first magnet 171 attract each other. The polarity of the surface of the first magnet 171 facing the magnetic conductive plate 121 along the first direction X is opposite to the polarity of the surface of the third magnet 183 facing the dynamic component 170 along the second direction Y. The third magnet 183 and the first magnet 171 attract each other. Illustratively, as shown in FIG. 9, the magnetic conductive plate 121 is disposed on the upper side surface of the first magnet 171 along the first direction X. The upper side surface of the first magnet 171 has an N-pole polarity. The surface of the second magnet 182 facing the dynamic component 170 along the second direction Y has an S-pole polarity. The surface of the third magnet 183 facing the dynamic component 170 along the second direction Y has an S-pole polarity. It should be noted that the dimensions and arrangement manners of the third magnet 183 may be the same as or similar to the dimensions and arrangement manners of the second magnet 182. For example, the third magnet 183 may also include at least two sub-magnets, where the at least two sub-magnets are respectively disposed on two opposite side surfaces of the circumferential side surface of the static component 160. The embedding depth of the third magnet 183 embedded in the corresponding groove structure may be the same as the embedding depth of the second magnet 182 embedded in the corresponding groove structure. At the balanced position, a distance in the first direction X between a centerline plane C6 of the third magnet 183 parallel to the second direction Y and a centerline plane C2 of the corresponding first magnetic conductive plate 121 parallel to the second direction Y may also be the first distance d2. For more details, please refer to the relevant description of the second magnet 182, which will not be described in detail here.

When the dynamic component 170 is in the balanced position, the direction of the attractive force of the second magnet 182 on the upper side surface of the first magnet 171 is upward along the first direction X, and the direction of the attractive force of the third magnet 183 on the upper side surface of the first magnet 171 is downward along the first direction X. The second magnet 182 and the third magnet 183 are approximately the same distance from the upper side surface of the first magnet 171. That is, the force of the second magnet 182 on the dynamic component 170 and the force of the third magnet 183 on the dynamic component 170 may counteract each other, so as to maintain the dynamic component 170 in the balanced position.

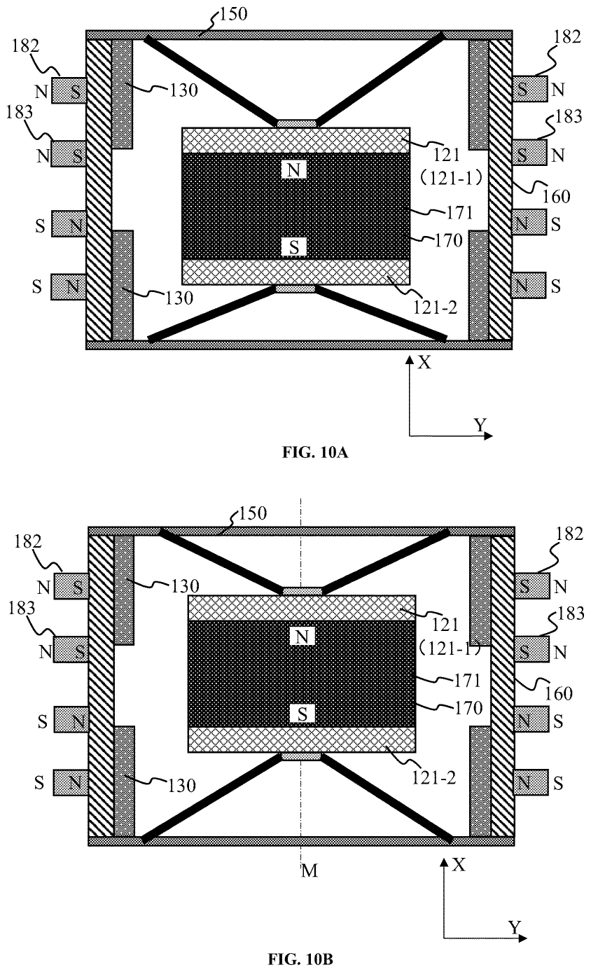

FIGS. 10A and 10B are schematic diagrams illustrating movement positions of a dynamic component according to some embodiments of the present disclosure.

Please refer to FIGS. 9 and 10A. In FIG. 9, the dynamic component 170 is in the balanced position. When the dynamic component 170 moves downward relative to the static component 160 in the first direction X as shown in FIG. 10A, the distance in the first direction X between the second magnet 182 and the upper side surface of the first magnet 171 increases, and the distance in the first direction X between the third magnet 183 and the upper side surface of the first magnet 171 decreases. The force of the second magnet 182 on the dynamic component 170 decreases, and the force of the third magnet 183 on the dynamic component 170 increases. However, because the direction of the force of the second magnet 182 on the dynamic component 170 is upward along the first direction X, and the direction of the force of the third magnet 183 on the dynamic component 170 is downward along the first direction X, the direction of the resultant force of the second magnet 182 and the third magnet 183 on the dynamic component 170 is downward along the first direction X, which is the same as the movement direction of the dynamic component 170, pointing away from the balanced position.

Please refer to FIGS. 9 and 10B. In FIG. 9, the dynamic component 170 is in the balanced position. When the dynamic component 170 moves upward relative to the static component 160 in the first direction X as shown in FIG. 10B, the distance in the first direction X between the second magnet 182 and the upper side surface of the first magnet 171 decreases, and the distance in the first direction X between the third magnet 183 and the upper side surface of the first magnet 171 increases. The force of the second magnet 182 on the dynamic component 170 increases, and the force of the third magnet 183 on the dynamic component 170 decreases. However, because the direction of the force of the second magnet 182 on the dynamic component 170 is upward along the first direction X, and the direction of the force of the third magnet 183 on the dynamic component 170 is downward along the first direction X, the direction of the resultant force of the second magnet 182 and the third magnet 183 on the dynamic component 170 is upward along the first direction X, which is the same as the movement direction of the dynamic component 170, pointing away from the balanced position.

It should be noted that for the content related to the force of the resilient plate assembly 150 on the dynamic component 170 during the movement of the dynamic component 170, please refer to the relevant description of FIGS. 3A and 3B mentioned above, which will not be repeated here.

In some embodiments, when the resilient plate assembly 150 only includes a vibration transmission plate, the first magnetic circuit assembly 140 may only include a magnetic conductive plate 121, and the voice coil assembly 130 may only include a corresponding voice coil. In some embodiments, when the resilient plate assembly 150 includes two vibration transmission plates (e.g., a first vibration transmission plate and a second vibration transmission plate), the first vibration transmission plate is connected to a first end of the dynamic component 170 along the first direction X, and the second vibration transmission plate is connected to a second end of the dynamic component 170 along the first direction X. The first end and the second end are two ends of the dynamic component 170 along the first direction X. The dynamic component 170 may include a first magnetic conductive plate 121-1 and a second magnetic conductive plate 121-2. The first vibration transmission plate connects the first magnetic conductive plate 121-1 and the static component 160, and the second vibration transmission plate connects the second magnetic conductive plate 121-2 and the static component 160. The voice coil assembly 130 includes a first voice coil and a second voice coil. At least a portion of the first voice coil is located in a region of the magnetic gap corresponding to the first end of the dynamic component 170 along the first direction X, and at least a portion of the second voice coil is located in a region of the magnetic gap corresponding to the second end of the dynamic component 170 along the first direction X. Specific structures can refer to the relevant description of FIG. 1 mentioned above, and will not be described in detail here.

Referring to FIG. 2B, in some embodiments, the auxiliary magnetic circuit assembly 180 further includes a fourth magnet 184. The polarity of the surface of the first magnet 171 facing the first magnetic conductive plate 121-1 along the first direction X is the same as the polarity of the surface of the second magnet 182 facing the dynamic component 170 along the second direction Y. The polarity of the surface of the first magnet 171 facing the second magnetic conductive plate 121-2 along the first direction X is the same as a polarity of a surface of the fourth magnet 184 facing the dynamic component 170 along the second direction Y. Illustratively, as shown in FIG. 2B, the first magnetic conductive plate 121-1 is disposed on the upper side surface of the first magnet 171 along the first direction X. The upper side surface of the first magnet 171 has an N-pole polarity. The surface of the second magnet 182 facing the dynamic component 170 along the second direction Y has an N-pole polarity. The second magnetic conductive plate 121-2 is disposed on the lower side surface of the first magnet 171 along the first direction X. The lower side surface of the first magnet 171 has an S-pole polarity. The surface of the fourth magnet 184 facing the dynamic component 170 along the second direction Y has an S-pole polarity. It should be noted that the dimension of the fourth magnet 184 is the same as the dimension of the second magnet 182. The arrangement manner of the fourth magnet 184 is also the same as the arrangement manner of the second magnet 182, which is disposed on the outer periphery side of the static component 160 away from the dynamic component 170 (e.g., attached to or embedded in a corresponding groove structure). An embedding depth of the fourth magnet 184 embedded in the corresponding groove structure may be the same as the embedding depth of the second magnet 182 embedded in the corresponding groove structure. For more content related to the fourth magnet 184, reference can be made to the relevant description of the second magnet 182, which will not be described in detail here.

Referring to FIG. 2B, when the dynamic component 170 is in the balanced position, the direction of the repulsive force of the second magnet 182 on the upper side surface of the first magnet 171 and the repulsive force of the fourth magnet 184 on the lower side surface of the first magnet 171 may counteract each other, so as to maintain the dynamic component 170 in the balanced position.

Referring to FIGS. 2B and 3A, when the dynamic component 170 moves downward relative to the static component 160 in the first direction X as shown in FIG. 3A, the distance in the first direction X between the second magnet 182 and the upper side surface of the first magnet 171 is closer, and the distance in the first direction X between the second magnet 182 and the lower side surface of the first magnet 171 is farther. The force of the second magnet 182 on the first magnet 171 is mainly the repulsive force of the second magnet 182 on the upper side surface of the first magnet 171, and the direction of the repulsive force is downward along the first direction X. A distance in the first direction X between the fourth magnet 184 and the lower side surface of the first magnet 171 is closer, and a distance in the first direction X between the fourth magnet 184 and the upper side surface of the first magnet 171 is farther. The force of the fourth magnet 184 on the first magnet 171 is mainly the repulsive force of the fourth magnet 184 on the lower side surface of the first magnet 171, and the direction of the repulsive force is downward along the first direction X. In summary, the direction of the resultant force of the second magnet 182 and the fourth magnet 184 on the dynamic component 170 is downward along the first direction X, which is the same as the movement direction of the dynamic component 170. That is, the second magnet 182 and the fourth magnet 184 jointly provide the compensating force to cause the dynamic component 170 to deviate away from the balanced position.

Referring to FIGS. 2B and 3B, when the dynamic component 170 moves upward relative to the static component 160 in the first direction X as shown in FIG. 3B, the distance in the first direction X between the second magnet 182 and the upper side surface of the first magnet 171 decreases, and the distance in the first direction X between the second magnet 182 and the lower side surface of the first magnet 171 is farther. The force of the second magnet 182 on the first magnet 171 is mainly the repulsive force of the second magnet 182 on the upper side surface of the first magnet 171, and the direction of the repulsive force is upward along the first direction X. The distance in the first direction X between the fourth magnet 184 and the lower side surface of the first magnet 171 is closer, and the distance in the first direction X between the fourth magnet 184 and the upper side surface of the first magnet 171 is farther. The force of the fourth magnet 184 on the first magnet 171 is mainly the repulsive force of the fourth magnet 184 on the lower side surface of the first magnet 171, and the direction of the repulsive force is upward along the first direction X. In summary, the direction of the resultant force of the second magnet 182 and the fourth magnet 184 on the dynamic component 170 is upward along the first direction X, which is the same as the movement direction of the dynamic component 170. That is, the second magnet 182 and the fourth magnet 184 jointly provide the compensating force to cause the dynamic component 170 to deviate away from the balanced position.

Considering the movement distance of the dynamic component 170 relative to the balanced position in the first direction X, for structural design considerations, to avoid an excessively large dimension of the transducer device 120, it is necessary to design an arrangement position of the second magnet 182. In some embodiments, at the balanced position, the distance (e.g., d2) in the first direction X between the centerline plane C2 of the first magnetic conductive plate 121-1 parallel to the second direction Y and the centerline plane C1 of the second magnet 182 parallel to the second direction Y is not greater than 0.8 mm. A distance in the first direction X between a centerline plane C4 of the second magnetic conductive plate 121-2 parallel to the second direction Y and a centerline plane C3 of the fourth magnet 184 parallel to the second direction Y is not greater than 0.8 mm. This is to ensure the mutual repulsion between the second magnet 182, the fourth magnet 184, and the first magnet 171, and to avoid the second magnet 182, the fourth magnet 184, and the first magnet 171 being too far apart.

In some embodiments, to enable flexible adjustment of the force provided by the auxiliary magnetic circuit assembly 180 on the dynamic component 170, an arrangement position of the auxiliary magnetic circuit assembly 180 can be designed.

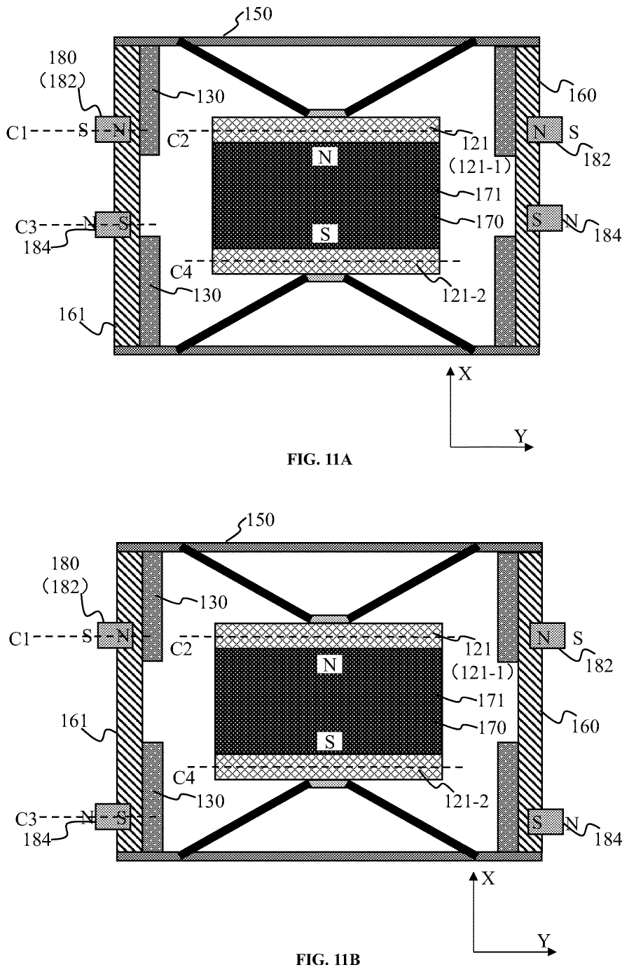

FIGS. 11A and 11B are schematic diagrams illustrating yet another exemplary structure of the transducer device according to some embodiments of the present disclosure.

Referring to FIG. 11A and FIG. 11B, in some embodiments, at the balanced position, the distance in the first direction X between the centerline plane C2 of the first magnetic conductive plate 121-1 parallel to the second direction Y and the centerline plane C1 of the second magnet 182 parallel to the second direction Y is 0 mm to 0.1 mm, and the distance in the first direction X between the centerline plane C4 of the second magnetic conductive plate 121-2 parallel to the second direction Y and the centerline plane C3 of the fourth magnet 184 parallel to the second direction Y is 0.1 mm to 0.8 mm. That is, the centerline plane C2 of the first magnetic conductive plate 121-1 and the centerline plane C1 of the second magnet 182 may coincide or approximately coincide in the first direction X. The centerline plane C4 of the second magnetic conductive plate 121-2 and the centerline plane C3 of the fourth magnet 184 may be staggered in the first direction X. The fourth magnet 184 may be staggered upward (as shown in FIG. 11A) or staggered downward (as shown in FIG. 11B) relative to the second magnetic conductive plate 121-2 in the first direction X.

Hereinafter, taking the fourth magnet 184 shown in FIG. 11A and FIG. 11B as an example, a relative position design of the magnet of the auxiliary magnetic circuit assembly 180 and the corresponding magnetic conductive plate 121 of the dynamic component 170, other than being flush, will be described.

In some embodiments, at the balanced position, the magnet of the auxiliary magnetic circuit assembly 180 may be located between the centerline plane C4 of the second magnetic conductive plate 121-2 and the centerline plane C2 of the first magnetic conductive plate 121-1 in the first direction X. For example, as shown in FIG. 11A, at the balanced position, when the centerline plane C3 of the fourth magnet 184 is located on a side of the centerline plane C4 of the second magnetic conductive plate 121-2 facing the first magnet 171 (that is, between the centerline plane C4 of the second magnetic conductive plate 121-2 and the centerline plane C2 of the first magnetic conductive plate 121-1), if a distance in the first direction X between the centerline plane C3 of the fourth magnet 184 and the centerline plane C4 of the corresponding second magnetic conductive plate 121-2 is too large, it may cause the fourth magnet 184 and the second magnet 182 to be too close to each other in the first direction X, which may affect an effect of the second magnet 182 on the first magnetic conductive plate 121-1, affect the compensating force provided by the auxiliary magnetic circuit assembly 180, and affect the vibration effect of the dynamic component 170.

In some embodiments, at the balanced position, the magnet of the auxiliary magnetic circuit assembly 180 is staggered from the dynamic component 170 in the first direction X. For example, as shown in FIG. 11B, at the balanced position, the centerline plane C3 of the fourth magnet 184 is located on a side of the centerline plane C4 of the second magnetic conductive plate 121-2 away from the first magnet 171. In order to ensure that the auxiliary magnetic circuit assembly 180 provides the compensating force to cause the dynamic component 170 to deviate away from the balanced position, a distance in the first direction X between the magnet of the auxiliary magnetic circuit assembly 180 and the dynamic component 170 should not be too large at the balanced position. During a downward vibration of the dynamic component 170 from the balanced position along the first direction X, the downward repulsive force provided by the second magnet 182 gradually decreases, while the repulsive force provided by the fourth magnet 184 first gradually increases and then gradually decreases. As the repulsive force provided by the fourth magnet 184 gradually increases, the direction of the repulsive force provided by the fourth magnet 184 is upward. As the repulsive force provided by the fourth magnet 184 gradually decreases, the direction of the repulsive force provided by the fourth magnet 184 is downward. When the repulsive force provided by the fourth magnet 184 is at its maximum, the centerline plane C3 of the fourth magnet 184 is flush with the centerline plane C4 of the second magnetic conductive plate 121-2. If the distance in the first direction X between the centerline plane C3 of the fourth magnet 184 and the centerline plane C4 of the corresponding second magnetic conductive plate 121-2 is too large, when the dynamic component 170 vibrates downward from the balanced position along the first direction X until the centerline plane C3 of the fourth magnet 184 is flush with the centerline plane C4 of the second magnetic conductive plate 121-2, the downward repulsive force provided by the second magnet 182 is too small, and an upward resultant force provided by the second magnet 182 and the fourth magnet 184 is too large, which may affect the vibration effect of the dynamic component 170.

In order to ensure the vibration effect of the dynamic component 170, at the balanced position, when the magnet of the auxiliary magnetic circuit assembly 180 is staggered from the dynamic component 170 in the first direction X (e.g., the fourth magnet 184 shown in FIG. 11A and FIG. 11B), the distance in the first direction X between the magnet and the corresponding magnetic conductive plate may be 0.1 mm to 0.4 mm. For example, the distance in the first direction X between the centerline plane C3 of the fourth magnet 184 shown in FIG. 11A and FIG. 11B and the centerline plane C4 of the corresponding second magnetic conductive plate 121-2 is 0.1 mm to 0.4 mm. It should be noted that, in some embodiments, a range of values for the foregoing distance is related to a maximum displacement of the dynamic component 170 relative to the balanced position. For example, referring to FIG. 11B, when the maximum displacement of the dynamic component 170 relative to the balanced position is 0.8 mm, when, at the balanced position, the centerline plane C3 of the fourth magnet 184 is located on a side of the centerline plane C4 of the second magnetic conductive plate 121-2 away from the first magnet 171, a maximum distance in the first direction X between the centerline plane C3 of the fourth magnet 184 and the centerline plane C4 of the corresponding second magnetic conductive plate 121-2 may be 0.4 mm.

In some embodiments, at the balanced position, the distance in the first direction X between the centerline plane C2 of the first magnetic conductive plate 121-1 parallel to the second direction Y and the centerline plane C1 of the second magnet 182 parallel to the second direction Y is 0 mm, and the distance in the first direction X between the centerline plane C4 of the second magnetic conductive plate 121-2 parallel to the second direction Y and the centerline plane C3 of the fourth magnet 184 parallel to the second direction Y is 0.1 mm to 0.4 mm.

In other embodiments, the first magnetic conductive plate 121-1 and the second magnet 182 may also be staggered upward or downward in the first direction X, and the second magnetic conductive plate 121-2 and the fourth magnet 184 may be flush or approximately flush. That is, at the balanced position, the distance in the first direction X between the centerline plane C4 of the second magnetic conductive plate 121-2 parallel to the second direction Y and the centerline plane C3 of the fourth magnet 184 parallel to the second direction Y is 0 mm to 0.1 mm, and the distance in the first direction X between the centerline plane C2 of the first magnetic conductive plate 121-1 parallel to the second direction Y and the centerline plane C1 of the second magnet 182 parallel to the second direction Y is 0.1 mm to 0.8 mm. In some embodiments, at the balanced position, the distance in the first direction X between the centerline plane C4 of the second magnetic conductive plate 121-2 parallel to the second direction Y and the centerline plane C3 of the fourth magnet 184 parallel to the second direction Y is 0 mm, and the distance in the first direction X between the centerline plane C2 of the first magnetic conductive plate 121-1 parallel to the second direction Y and the centerline plane C1 of the second magnet 182 parallel to the second direction Y is 0.1 mm to 0.4 mm.

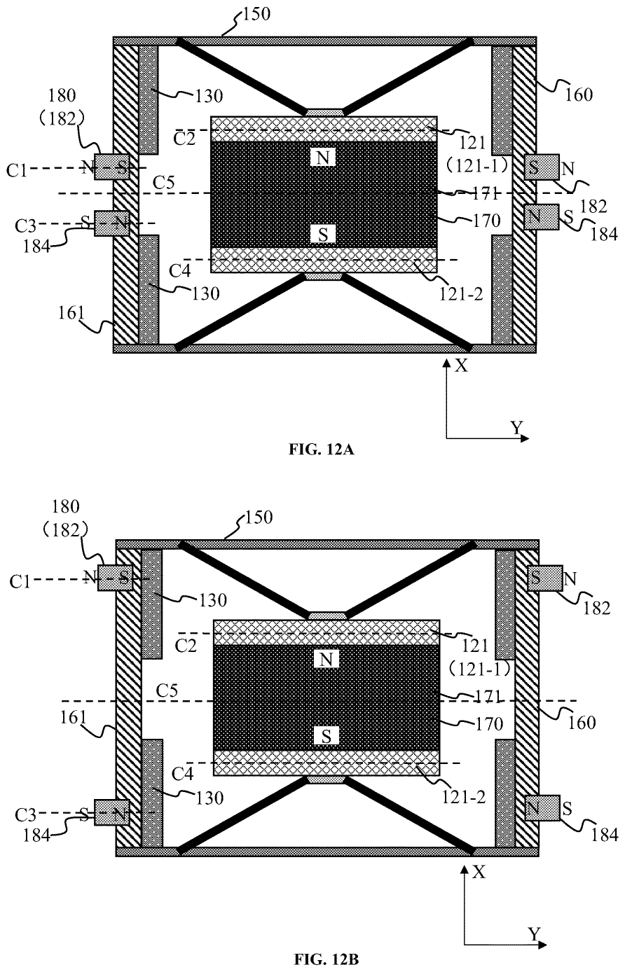

FIGS. 12A and 12B are schematic diagrams illustrating yet another exemplary structure of the transducer device according to some embodiments of the present disclosure.

Referring to FIG. 12A, in some embodiments, in the first direction X, the centerline plane C1 of the second magnet 182 parallel to the second direction Y is located between the centerline plane C2 of the first magnetic conductive plate 121-1 parallel to the second direction Y and a centerline plane C5 of the first magnet 171 parallel to the second direction Y. The centerline plane C3 of the fourth magnet 184 parallel to the second direction Y is located between the centerline plane C4 of the second magnetic conductive plate 121-2 parallel to the second direction Y and the centerline plane C5 of the first magnet 171 parallel to the second direction Y. That is, the second magnet 182 and the fourth magnet 184 are offset in the opposite directions, and are respectively offset inward towards the first magnet 171 in the first direction X.

Referring to FIG. 12B, in other embodiments, in the first direction X, the centerline plane C1 of the second magnet 182 parallel to the second direction Y is located on a side of the centerline plane C2 of the first magnetic conductive plate 121-1 parallel to the second direction Y away from the first magnet 171, and the centerline plane C3 of the fourth magnet 184 parallel to the second direction Y is located on a side of the centerline plane C4 of the second magnetic conductive plate 121-2 parallel to the second direction Y away from the first magnet 171. That is, the second magnet 182 and the fourth magnet 184 are offset in the opposite directions, and are respectively offset outward relative to the first magnet 171 in the first direction X.

In some embodiments, at the balanced position, the distance in the first direction X between the centerline plane C4 of the second magnetic conductive plate 121-2 parallel to the second direction Y and the centerline plane C3 of the fourth magnet 184 parallel to the second direction Y is 0.1 mm to 0.4 mm, and the distance in the first direction X between the centerline plane C2 of the first magnetic conductive plate 121-1 parallel to the second direction Y and the centerline plane C1 of the second magnet 182 parallel to the second direction Y is 0.1 mm to 0.4 mm.

It should be noted that, for the transducer device 120 shown in FIG. 12A and FIG. 12B, in order to make the direction of the resultant force of the second magnet 182 and the fourth magnet 184 on the dynamic component 170 the same as the moving direction of the dynamic component 170 and pointing away from the balanced position, the polarity of the surface of the first magnet 171 facing the first magnetic conductive plate 121-1 along the first direction X is opposite to the polarity of the surface of the second magnet 182 facing the dynamic component 170 along the second direction Y, and the polarity of the surface of the first magnet 171 facing the second magnetic conductive plate 121-2 along the first direction X is opposite to the polarity of the surface of the fourth magnet 184 facing the dynamic component 170 along the second direction Y.

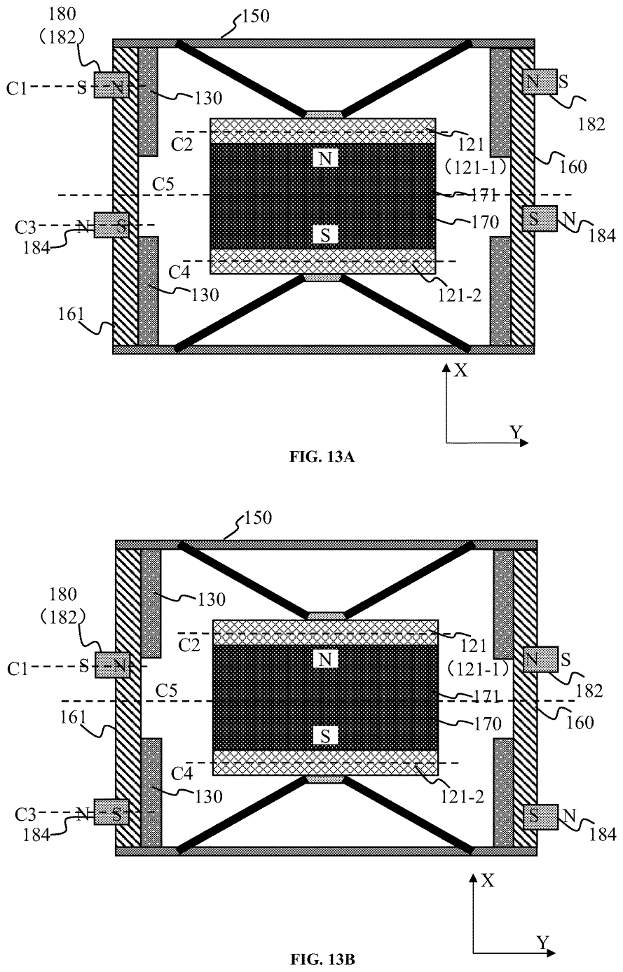

FIGS. 13A and 13B are schematic diagrams illustrating yet another exemplary structure of the transducer device according to some embodiments of the present disclosure.

Referring to FIG. 13A, in some embodiments, in the first direction X, the centerline plane C1 of the second magnet 182 parallel to the second direction Y is located on the side of the centerline plane C2 of the first magnetic conductive plate 121-1 parallel to the second direction Y away from the first magnet 171, and the centerline plane C3 of the fourth magnet 184 parallel to the second direction Y is located between the centerline plane C4 of the second magnetic conductive plate 121-2 parallel to the second direction Y and the centerline plane C5 of the first magnet 171 parallel to the second direction Y. That is, the second magnet 182 and the fourth magnet 184 are offset in the same direction, and both the second magnet 182 and the fourth magnet 184 are offset upward in the first direction X.

Referring to FIG. 13B, in other embodiments, in the first direction X, the centerline plane C1 of the second magnet 182 parallel to the second direction Y is located between the centerline plane C2 of the first magnetic conductive plate 121-1 parallel to the second direction Y and the centerline plane C5 of the first magnet 171 parallel to the second direction Y, and the centerline plane C3 of the fourth magnet 184 parallel to the second direction Y is located on the side of the centerline plane C4 of the second magnetic conductive plate 121-2 parallel to the second direction Y away from the first magnet 171. That is, the second magnet 182 and the fourth magnet 184 are offset in the same direction, and both the second magnet 182 and the fourth magnet 184 are offset downward in the first direction X.

In some embodiments, at the balanced position, the distance in the first direction X between the centerline plane C4 of the second magnetic conductive plate 121-2 parallel to the second direction Y and the centerline plane C3 of the fourth magnet 184 parallel to the second direction Y is 0.1 mm to 0.4 mm, and the distance in the first direction X between the centerline plane C2 of the first magnetic conductive plate 121-1 parallel to the second direction Y and the centerline plane C1 of the second magnet 182 parallel to the second direction Y is 0.1 mm to 0.4 mm.

It should be noted that, regarding the arrangement of the second magnet 182 and the fourth magnet 184 mentioned in FIG. 11A to FIG. 13B, at the balanced position, when a magnet is located between the centerline plane C2 of the first magnetic conductive plate 121-1 and the centerline plane C4 of the second magnetic conductive plate 121-2, a position design of the magnet may refer to the arrangement design of the fourth magnet 184 shown in FIG. 11A. At the balanced position, when a magnet is staggered from the dynamic component 170 in the first direction X, a position design of the magnet may refer to the arrangement design of the fourth magnet 184 shown in FIG. 11B.

Referring to FIG. 9, in some embodiments, the auxiliary magnetic circuit assembly 180 further includes the third magnet 183. The second magnet 182 and the third magnet 183 are spaced apart in the first direction X, and in the first direction X, the second magnet 182 and the third magnet 183 are respectively located on two sides of the first magnetic conductive plate 121-1. In the first direction X, the centerline plane C1 of the second magnet 182 parallel to the second direction Y and a centerline plane C6 of the third magnet 183 parallel to the second direction Y are both located on a side of the centerline plane C5 of the first magnet 171 parallel to the second direction Y facing the first magnetic conductive plate 121-1.

The polarity of the surface of the first magnet 171 facing the first magnetic conductive plate 121-1 along the first direction X is opposite to the polarity of the surface of the second magnet 182 facing the dynamic component 170 along the second direction Y, and the second magnet 182 and the first magnet 171 attract each other. The polarity of the surface of the first magnet 171 facing the first magnetic conductive plate 121-1 along the first direction X is opposite to a polarity of a surface of the third magnet 183 facing the dynamic component 170 along the second direction Y, and the third magnet 183 and the first magnet 171 attract each other. In some embodiments, the auxiliary magnetic circuit assembly 180 further includes a fifth magnet 185, the fourth magnet 184 and the fifth magnet 185 are spaced apart in the first direction X, and in the first direction X, the fourth magnet 184 and the fifth magnet 185 are respectively located on two sides of the second magnetic conductive plate 121-2. Furthermore, in the first direction X, the centerline plane C3 of the fourth magnet 184 parallel to the second direction Y and a centerline plane C7 of the fifth magnet 185 parallel to the second direction Y are both located on a side of the centerline plane C5 of the first magnet 171 parallel to the second direction Y facing the second magnetic conductive plate 121-2.

The polarity of the surface of the first magnet 171 facing the second magnetic conductive plate 121-2 along the first direction X is opposite to the polarity of the surface of the fourth magnet 184 facing the dynamic component 170 along the second direction Y, and the fourth magnet 184 and the first magnet 171 attract each other; the polarity of the surface of the first magnet 171 facing the second magnetic conductive plate 121-2 along the first direction X is opposite to the polarity of the surface of the fifth magnet 185 facing the dynamic component 170 along the second direction Y, and the fifth magnet 185 and the first magnet 171 attract each other.

Referring to FIG. 9, when the dynamic component 170 is in the balanced position, the attractive force of the second magnet 182 on the upper side surface of the first magnet 171 is directed upward along the first direction X, and the attractive force of the third magnet 183 on the upper side surface of the first magnet 171 is directed downward along the first direction X. The force of the second magnet 182 on the dynamic component 170 and the force of the third magnet 183 on the dynamic component 170 may cancel each other out. The attractive force of the fourth magnet 184 on the lower side surface of the first magnet 171 is directed upward along the first direction X, and the attractive force of the fifth magnet 185 on the lower side surface of the first magnet 171 is directed downward along the first direction X. The force of the fourth magnet 184 on the dynamic component 170 and the force of the fifth magnet 185 on the dynamic component 170 may cancel each other out. Thereby enabling the dynamic component 170 to be maintained in the balanced position.

Referring to FIG. 9 and FIG. 10A, when the dynamic component 170 moves downward along the first direction X relative to the static component 160 as shown in FIG. 10A, the distance between the second magnet 182 and the upper side surface of the first magnet 171 increases, and the distance between the third magnet 183 and the upper side surface of the first magnet 171 decreases. The force of the second magnet 182 on the dynamic component 170 decreases, and the force of the third magnet 183 on the dynamic component 170 increases. Since the direction of the force of the second magnet 182 on the dynamic component 170 is upward along the first direction X, and the direction of the force of the third magnet 183 on the dynamic component 170 is downward along the first direction X, the direction of the resultant force of the second magnet 182 and the third magnet 183 on the dynamic component 170 is downward along the first direction X, which is the same as the moving direction of the dynamic component 170, and points in a direction away from the balanced position. When the dynamic component 170 moves downward along the first direction X relative to the static component 160 as shown in FIG. 10A, the distance between the fourth magnet 184 and the lower side surface of the first magnet 171 increases, and the distance between the fifth magnet 185 and the lower side surface of the first magnet 171 decreases. The force of the fourth magnet 184 on the dynamic component 170 decreases, and the force of the fifth magnet 185 on the dynamic component 170 increases. Since the direction of the force of the fourth magnet 184 on the dynamic component 170 is upward along the first direction X, and the direction of the force of the fifth magnet 185 on the dynamic component 170 is downward along the first direction X, the direction of the resultant force of the fourth magnet 184 and the fifth magnet 185 on the dynamic component 170 is downward along the first direction X, which is the same as the moving direction of the dynamic component 170, and points in a direction away from the balanced position. In summary, the auxiliary magnetic circuit assembly 180 provides the dynamic component 170 with the force pointing in a direction away from the balanced position.

Referring to FIG. 9 and FIG. 10B, when the dynamic component 170 moves upward along the first direction X relative to the static component 160 as shown in FIG. 10B, the distance between the second magnet 182 and the upper side surface of the first magnet 171 decreases, and the distance between the third magnet 183 and the upper side surface of the first magnet 171 increases. The force of the second magnet 182 on the dynamic component 170 increases, and the force of the third magnet 183 on the dynamic component 170 decreases. Since the direction of the force of the second magnet 182 on the dynamic component 170 is upward along the first direction X, and the direction of the force of the third magnet 183 on the dynamic component 170 is downward along the first direction X, the direction of the resultant force of the second magnet 182 and the third magnet 183 on the dynamic component 170 is upward along the first direction X, which is the same as the moving direction of the dynamic component 170, and points in a direction away from the balanced position. When the dynamic component 170 moves upward along the first direction X relative to the static component 160 as shown in FIG. 10B, the distance between the fourth magnet 184 and the lower side surface of the first magnet 171 decreases, and the distance between the fifth magnet 185 and the lower side surface of the first magnet 171 increases. The force of the fourth magnet 184 on the dynamic component 170 increases, and the force of the fifth magnet 185 on the dynamic component 170 decreases. Since the direction of the force of the fourth magnet 184 on the dynamic component 170 is upward along the first direction X, and the direction of the force of the fifth magnet 185 on the dynamic component 170 is downward along the first direction X, the direction of the resultant force of the fourth magnet 184 and the fifth magnet 185 on the dynamic component 170 is upward along the first direction X, which is the same as the moving direction of the dynamic component 170, and points in a direction away from the balanced position. In summary, the auxiliary magnetic circuit assembly 180 provides the dynamic component 170 with the force pointing in a direction away from the balanced position.

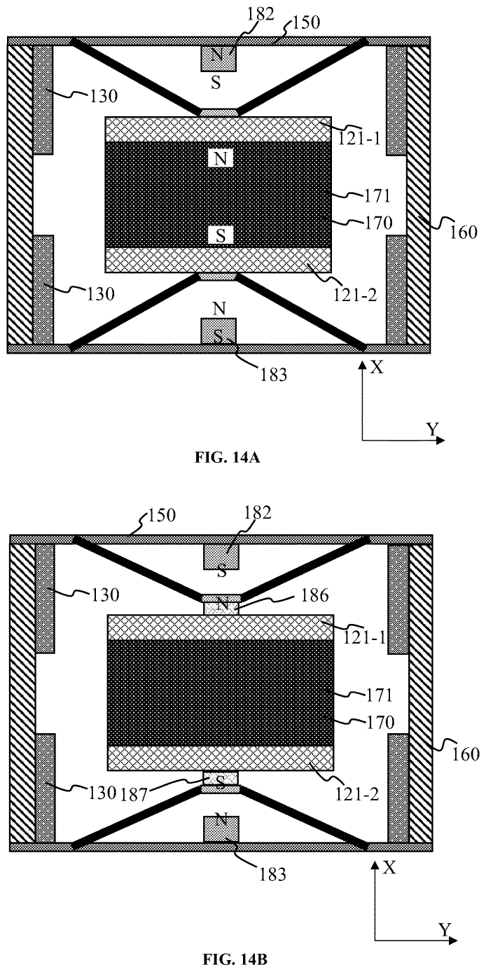

FIG. 14A is a schematic diagram illustrating yet another exemplary structure of the transducer device according to some embodiments of the present disclosure.

Referring to FIG. 14A, in some embodiments, the auxiliary magnetic circuit assembly 180 includes the second magnet 182 and the third magnet 183, the second magnet 182 and the first magnetic conductive plate 121-1 are spaced apart along the first direction X, and the third magnet 183 and the second magnetic conductive plate 121-2 are spaced apart along the first direction X. In some embodiments, the second magnet 182 and the third magnet 183 may be disposed on the housing 110. The polarity of the surface of the first magnet 171 facing the first magnetic conductive plate 121-1 is opposite to the polarity of the surface of the second magnet 182 facing the first magnetic conductive plate 121-1 along the first direction X. The polarity of the surface of the first magnet 171 facing the second magnetic conductive plate 121-2 is opposite to the polarity of the surface of the third magnet 183 facing the second magnetic conductive plate 121-2 along the first direction X. For example, as shown in FIG. 14A, the first magnetic conductive plate 121-1 is disposed on the upper side surface of the first magnet 171 along the first direction X, and the second magnetic conductive plate 121-2 is disposed on the lower side surface of the first magnet 171 along the first direction X. The upper side surface of the first magnet 171 is an N-pole, and the surface of the second magnet 182 facing the first magnetic conductive plate 121-1 along the first direction X is an S-pole; the lower side surface of the first magnet 171 is an S-pole, and the surface of the third magnet 183 facing the second magnetic conductive plate 121-2 along the first direction X is an N-pole. In this case, the polarization direction of the second magnet 182 and/or the third magnet 183 is the same as or parallel to the polarization direction of the first magnet 171, wherein the aforementioned same or parallel includes approximately the same or approximately parallel.

It should be noted that the second magnet 182 and the third magnet 183 shown in FIG. 14A may also be disposed on a side wall of the static component 160. For example, they may be disposed on the inner side wall of the static component 160, or may be disposed on the outer side wall of the static component 160 in the same manner as the second magnet 182 and the fourth magnet 184 shown in FIG. 12B. When the second magnet 182 and the third magnet 183 are disposed on the side wall of the static component 160, referring to the design of the relative position between the fourth magnet 184 and the corresponding second magnetic conductive plate 121-2 in FIG. 11B of the foregoing description, a spacing along the first direction X between the centerline plane of the second magnet 182 parallel to the second direction Y and the centerline plane of the corresponding first magnetic conductive plate 121-1 parallel to the second direction Y may be greater than or equal to 0.4 mm; and a spacing along the first direction X between the centerline plane of the third magnet 183 parallel to the second direction Y and the centerline plane of the corresponding second magnetic conductive plate 121-2 parallel to the second direction Y may be greater than or equal to 0.4 mm. Further, considering both a displacement amplitude of the dynamic component 170 relative to the balanced position and a dimension design of the transducer device 120, when the second magnet 182 and the third magnet 183 are disposed on the side wall of the static component 160, the spacing along the first direction X between the centerline plane of the second magnet 182 parallel to the second direction Y and the centerline plane of the corresponding first magnetic conductive plate 121-1 parallel to the second direction Y may be less than or equal to 0.8 mm; and the spacing along the first direction X between the centerline plane of the third magnet 183 parallel to the second direction Y and the centerline plane of the corresponding second magnetic conductive plate 121-2 parallel to the second direction Y may be less than or equal to 0.8 mm.

When the dynamic component 170 is in the balanced position, the attractive force of the second magnet 182 on the upper side surface of the first magnet 171 is directed upward along the first direction X, and the attractive force of the third magnet 183 on the lower side surface of the first magnet 171 is directed downward along the first direction X. The force of the second magnet 182 on the dynamic component 170 and the force of the third magnet 183 on the dynamic component 170 may cancel each other out, thereby enabling the dynamic component 170 to be maintained in the balanced position.

When the dynamic component 170 moves downward along the first direction X relative to the static component 160, the distance between the second magnet 182 and the upper side surface of the first magnet 171 increases, and the distance between the third magnet 183 and the lower side surface of the first magnet 171 decreases. The force of the second magnet 182 on the dynamic component 170 decreases, and the force of the third magnet 183 on the dynamic component 170 increases. Since the direction of the force of the second magnet 182 on the dynamic component 170 is upward along the first direction X, and the direction of the force of the third magnet 183 on the dynamic component 170 is downward along the first direction X, the direction of the resultant force of the second magnet 182 and the third magnet 183 on the dynamic component 170 is downward along the first direction X, which is the same as the moving direction of the dynamic component 170, and points in a direction away from the balanced position.

When the dynamic component 170 moves upward along the first direction X relative to the static component 160, the distance between the second magnet 182 and the upper side surface of the first magnet 171 decreases, and the distance between the third magnet 183 and the lower side surface of the first magnet 171 increases. The force of the second magnet 182 on the dynamic component 170 increases, and the force of the third magnet 183 on the dynamic component 170 decreases. Since the direction of the force of the second magnet 182 on the dynamic component 170 is upward along the first direction X, and the direction of the force of the third magnet 183 on the dynamic component 170 is downward along the first direction X, the direction of the resultant force of the second magnet 182 and the third magnet 183 on the dynamic component 170 is upward along the first direction X, which is the same as the moving direction of the dynamic component 170, and points in a direction away from the balanced position.

FIG. 14B is a schematic diagram illustrating yet another exemplary structure of the transducer device according to some embodiments of the present disclosure.

Referring to FIG. 14B, a difference between the transducer device 120 shown in FIG. 14B and the transducer device 120 shown in FIG. 14A is that the auxiliary magnetic circuit assembly 180 further includes a sixth magnet 186 and a seventh magnet 187, the sixth magnet 186 is disposed on the first magnetic conductive plate 121-1, and the seventh magnet 187 is disposed on the second magnetic conductive plate 121-2. The second magnet 182 and the sixth magnet 186 are spaced apart along the first direction X, and the third magnet 183 and the seventh magnet 187 are spaced apart along the first direction X. A polarity of a surface of the sixth magnet 186 facing the second magnet 182 is opposite to a polarity of a surface of the second magnet 182 facing the sixth magnet 186. A polarity of a surface of the seventh magnet 187 facing the third magnet 183 is opposite to a polarity of a surface of the third magnet 183 facing the seventh magnet 187. For example, as shown in FIG. 14B, the first magnetic conductive plate 121-1 is disposed on the upper side surface of the first magnet 171 along the first direction X, and the second magnetic conductive plate 121-2 is disposed on the lower side surface of the first magnet 171 along the first direction X. The surface of the sixth magnet 186 facing the second magnet 182 is an N-pole, the surface of the second magnet 182 facing the sixth magnet 186 is an S-pole, the surface of the seventh magnet 187 facing the third magnet 183 is an S-pole, and the surface of the third magnet 183 facing the seventh magnet 187 is an N-pole. The second magnet 182 and the sixth magnet 186 attract each other, and the third magnet 183 and the seventh magnet 187 attract each other. Through the disposition of the sixth magnet 186 and the seventh magnet 187, it may be avoided that the second magnet 182 and the third magnet 183 attract magnetic field lines in the corresponding magnetic conductive plates and thus weaken the magnetic field intensity at the voice coil assembly 130, thereby ensuring that the transducer device 120 has the strong driving force, and ensuring the output of the loudspeaker 100.

The basic concepts have been described above. Apparently, for those skilled in the art, the detailed disclosure above is merely by way of example, and does not constitute a limitation on the present disclosure. Although not expressly stated herein, a person skilled in the art may make various modifications, improvements, and revisions to the present disclosure, for. Such modifications, improvements, and revisions are suggested in the present disclosure, and thus such modifications, improvements, and revisions are still within the spirit and scope of the exemplary embodiments of the present disclosure.

Additionally, the present disclosure uses specific terms to describe the embodiments of the present disclosure. For example, “an embodiment”, “one embodiment”, and/or “some embodiments” refers to a certain feature, structure, or characteristic related to at least one embodiment of the present disclosure. Therefore, it should be emphasized and noted that “an embodiment”, “one embodiment”, or “an alternative embodiment” mentioned two or more times in different locations in the present disclosure does not necessarily refer to the same embodiment. Furthermore, certain features, structures, or characteristics in one or more embodiments of the present disclosure may be appropriately combined.

Similarly, it should be noted that, in order to simplify the representation of the disclosure of the present disclosure and thereby aid in understanding one or more inventive embodiments, various features may sometimes be grouped into one embodiment, a figure, or a description thereof in the preceding description of the embodiments of the present disclosure. However, this manner of disclosure does not mean that the features required by the subject matter of the present disclosure are more numerous than the features recited in the claims. In fact, the features of an embodiment may be fewer than all the features of a single embodiment disclosed above.

Finally, it should be understood that the embodiments described in the present disclosure are merely for illustrating the principles of the embodiments of the present disclosure. Other variations may also fall within the scope of the present disclosure. Therefore, by way of example and not by way of limitation, alternative configurations of the embodiments of the present disclosure may be considered consistent with the teachings of the present disclosure. Accordingly, the embodiments of the present disclosure are not limited to the embodiments expressly introduced and described herein. Please amend the claims as indicated below. This listing of claims will replace all prior versions and listings of claims in the application:

1. A transducer device, comprising:
a first magnetic circuit assembly, including a dynamic component and a static component, wherein the static component is arranged to surround the dynamic component, and the dynamic component includes a first magnet;
a voice coil assembly, wherein the voice coil assembly is fixed to the static component, at least a portion of the voice coil assembly is located in a magnetic gap between the static component and the dynamic component, the dynamic component is movable relative to the voice coil assembly and the static component, and the voice coil assembly includes at least one voice coil;
a resilient plate assembly, configured to connect the dynamic component and the static component and to allow the dynamic component to move relative to the static component in a first direction, wherein the first direction is parallel to an axis of the voice coil assembly; and
an auxiliary magnetic circuit assembly including a second magnet and a third magnet, wherein the second magnet and the third magnet are spaced apart in the first direction, both the second magnet and the third magnet are spaced apart from the first magnet in a second direction, and the second direction is perpendicular to the axis of the voice coil assembly;
wherein the dynamic component further includes a magnetic conductive plate, the magnetic conductive plate is disposed on a surface of the first magnet along the first direction, a polarity of a surface of the first magnet facing the magnetic conductive plate along the first direction is opposite to a polarity of a surface of the second magnet facing the dynamic component along the second direction, and the polarity of the surface of the first magnet facing the magnetic conductive plate along the first direction is opposite to a polarity of a surface of the third magnet facing the dynamic component along the second direction; and
in the first direction, the second magnet and the third magnet are respectively located on two sides of the magnetic conductive plate.

2. The transducer device of claim 1, wherein an angle between a polarization direction of the first magnetic circuit assembly and a polarization direction of the second magnet or the third magnet is 80°-100°.

3. (canceled)

4. The transducer device of claim 1, wherein, during a movement of the dynamic component relative to the static component, the resilient plate assembly provides a restoring force to restore the dynamic component to a balanced position; the auxiliary magnetic circuit assembly interacts with the first magnetic circuit assembly to provide a compensating force to cause the dynamic component to deviate away from the balanced position; and the balanced position is a position of the dynamic component relative to the static component when the voice coil assembly is not energized.

5. The transducer device of claim 1, wherein the second magnet and the third magnet are disposed on an outer periphery side of the static component away from the dynamic component.

6. The transducer device of claim 5, wherein the second magnet and the third magnet are attached to the outer periphery side of the static component.

7. The transducer device of claim 5, wherein two groove structures are provided on the outer periphery side of the static component, and the second magnet and the third magnet are respectively embedded in the corresponding groove structures.

8. The transducer device of claim 7, wherein a ratio of an embedding depth of the second magnet embedded in the corresponding groove structure to a dimension of the static component in the second direction is within a range of 0.01-0.95; and
a ratio of an embedding depth of the third magnet embedded in the corresponding groove structure to the dimension of the static component in the second direction is within a range of 0.01-0.95.

9. The transducer device of claim 7, wherein a ratio of an embedding depth of the second magnet embedded in the corresponding groove structure to a dimension of the static component in the second direction is within a range of 0.5-1; and
a ratio of an embedding depth of the third magnet embedded in the corresponding groove structure to the dimension of the static component in the second direction is within a range of 0.5-1.

10. The transducer device of claim 5, wherein, at the balanced position, a first distance in the first direction between a centerline plane of the magnetic conductive plate and a centerline plane of the second magnet is less than or equal to 0.8 mm, and the centerline plane of the magnetic conductive plate and the centerline plane of the second magnet are parallel to the second direction.

11. The transducer device of claim 10, wherein a ratio of the first distance to a thickness of the second magnet in the first direction is within a range of 0-1.3.

12. The transducer device of claim 4, wherein, in the second direction, a second distance between a side surface of the second magnet facing the first magnet and a side surface of the magnetic conductive plate facing the second magnet is within a range of 0.4 mm-1.9 mm.

13. The transducer device of claim 12, wherein a ratio of the second distance to a width of the second magnet in the second direction is within a range of 0.3-3.2.

14. The transducer device of claim 1, wherein a ratio of a width of the second magnet in the second direction to a dimension of the static component in the second direction is within a range of 0.6-2.

15. The transducer device of claim 14, wherein the width of the second magnet in the second direction is within a range of 0.6 mm-1.2 mm.

16. The transducer device of claim 1, wherein the second magnet includes at least two independent sub-magnets, the at least two sub-magnets are disposed on an outer periphery side of the static component away from the dynamic component, and the at least two sub-magnets are respectively disposed on two opposite side surfaces of a circumferential side surface of the static component.

17. The transducer device of claim 16, wherein a cross-sectional shape of the static component perpendicular to the first direction is a racetrack shape or a rectangle shape, and the at least two sub-magnets are respectively disposed on outer side surfaces corresponding to two long sides of the cross-sectional shape of the static component.

18. The transducer device of claim 1, wherein the voice coil assembly is attached to an inner side surface of the static component facing the dynamic component; or,
a step portion is provided on the inner side surface of the static component, and the voice coil assembly is disposed on the step portion.

19. The transducer device of claim 1, wherein the resilient plate assembly includes a first vibration transmission plate and a second vibration transmission plate, the first vibration transmission plate is connected to a first end of the dynamic component along the first direction, and the second vibration transmission plate is connected to a second end of the dynamic component along the first direction; and
the voice coil assembly includes a first voice coil and a second voice coil, at least a portion of the first voice coil is located in a region of the magnetic gap corresponding to the first end of the dynamic component along the first direction, and at least a portion of the second voice coil is located in a region of the magnetic gap corresponding to the second end of the dynamic component along the first direction.

20. The transducer device of claim 19, wherein the first vibration transmission plate and the second vibration transmission plate allow the dynamic component to vibrate relative to the static component, and the transducer device has at least one resonance peak within a frequency range of 100 Hz-200 Hz.

21. The transducer device of claim 19, wherein the dynamic component includes a first magnetic conductive plate and a second magnetic conductive plate, and the first magnetic conductive plate and the second magnetic conductive plate are respectively located on two surfaces of the first magnet along the first direction;
a polarity of a surface of the first magnet facing the first magnetic conductive plate along the first direction is opposite to a polarity of a surface of the second magnet facing the dynamic component along the second direction, and the polarity of the surface of the first magnet facing the first magnetic conductive plate along the first direction is opposite to a polarity of a surface of the third magnet facing the dynamic component along the second direction; in the first direction, the second magnet and the third magnet are respectively located on two sides of the first magnetic conductive plate, both a centerline plane of the second magnet and a centerline plane of the third magnet are located on a side of a centerline plane of the first magnet facing the first magnetic conductive plate, and the centerline plane of the second magnet, the centerline plane of the third magnet and the centerline plane of the first magnet are parallel to the second direction;
the auxiliary magnetic circuit assembly further includes a fourth magnet and a fifth magnet, the fourth magnet and the fifth magnet are spaced apart in the first direction, a polarity of a surface of the first magnet facing the second magnetic conductive plate along the first direction is opposite to a polarity of a surface of the fourth magnet facing the dynamic component along the second direction, and the polarity of the surface of the first magnet facing the second magnetic conductive plate along the first direction is opposite to a polarity of a surface of the fifth magnet facing the dynamic component along the second direction; in the first direction, the fourth magnet and the fifth magnet are respectively located on two sides of the second magnetic conductive plate, both a centerline plane of the fourth magnet and a centerline plane of the fifth magnet are located on a side of the centerline plane of the first magnet facing the second magnetic conductive plate, and the centerline plane of the fourth magnet, the centerline plane of the fifth magnet and the centerline plane of the first magnet are parallel to the second direction.
